(19) United States
(12) Patent Application Publication
(10) Pub. No.: US 2026/0329813 A1
(43) Pub. Date: Oct. 22, 2026

(54) ENHANCED DATA EXTRACTION

(71) Applicant: Fidelity Information Services, LLC, Jacksonville, FL (US)

(72) Inventor: Raghavendran Sekaran, Chennai (IN)

(21) Appl. No.: 19/404,328

(22) Filed: Dec. 1, 2025

(30) Foreign Application Priority Data
Apr. 22, 2025 (IN) 202511038639

(51) Int. Cl. G06F 16/16

(52) U.S. Cl. CPC G06F 16/168

(57) ABSTRACT

The present disclosure provides systems and methods that facilitate the determination of data for use in populating fields of a data structure based on images and other raw data. An image may be processed by a data extraction function to identify and label extracted data represented in the image. This information may be used to populate fields in a data structure associated with the labels. The image may be presented to a user for selection of portions of the image and the extracted data derived from those portions may be associated with unpopulated fields of the data structure. The user may further adjust the accuracy of label and extracted data associations. These adjustments as well as the association determined based on selection portions of the image may be used to further configure the data extraction function to automatically improve it capabilities.

### CROSS-REFERENCE TO RELATED APPLICATION

This application claims foreign priority to Indian Application No. 202511038639, filed on Apr. 22, 2025, and entitled “Enhanced Data Extraction,” the entirety of which is incorporated herein by reference.

### TECHNICAL FIELD

This disclosure relates to computer-implemented systems and methods for extracting data from images of documents and other types of data files.

### BACKGROUND

With the advance of computing technology, text recognition and classification systems have become increasingly capable of extracting and classifying text information from documents (e.g., images of documents generated by document scanners) and other data sources. However, with the nearly infinite combinations of text, fonts, images, formats, and configurations that may be included in a document, it remains a challenge to accurately extract useful information from many documents. For example, textual information may be presented in relative isolation rather than proximate to identifiers that may be useful for categorizing such information. In other examples, textual information may be configured within a document proximate to an uncommon identifier, inhibiting the ability of a text recognition and classification system to accurately categorize such information. In still other examples, textual information may be presented in a highly stylized manner and/or integrated into an image or illustration, which may also hinder the ability of a text recognition and classification system to accurately categorize such information. For the foregoing reasons, there is a need for improved systems and methods for extracting useful information from documents and other data sources.

### SUMMARY OF THE INVENTION

The described innovations include a system for populating data structure fields with legible data extracted from computer-readable files, where the system includes one or more processors; and non-transitory computer-readable media storing instructions that, when executed by the one or more processors, cause the system to perform operations including executing a data extraction function using a computer-readable data file as input to generate legible data as output; causing a display element comprising the computer-readable data file to be rendered on a user device via a user interface; causing a data entry field to be rendered on the user device via the user interface, the data entry field comprising metadata indicating a data field of a data structure associated with the computer-readable data file; causing a data selection input element associated with the data entry field to be rendered proximate to the data entry field on the user device via the user interface; receiving input data from the data selection input element, the input data indicating a portion of the computer-readable data file and the metadata indicating the data field; determining a subset of the legible data associated with the portion of the computer-readable data file; determining the data field based at least in part on the metadata indicating the data field; based at least in part on determining the data field, storing the subset of the legible data in the data field; and causing the subset of the legible data to be rendered in the data entry field on the user device via the user interface.

In examples, the operations may include determining a second subset of the legible data associated with a second data field of the data structure; causing a second data entry field associated with the second data field to be rendered on the user device via the user interface; and causing the second subset of the legible data to be rendered in the second data entry field on the user device via the user interface. The operations may also, or instead, include executing the data extraction function using the computer-readable data file as the input to generate second output indicating the second subset of the legible data, a label associated with the second data field, and an association between the second subset of the legible data and the label; and storing the second subset of the legible data in the second data field based at least in part on the label. In examples, the second output may indicate a confidence value representing a confidence of the association between the second subset of the legible data and the label, and the operations may include storing the confidence value in the data structure; associating the confidence value with the second data field in the data structure; and causing a confidence indicator representing the confidence value to be rendered proximate to the second data entry field on the user device via the user interface. The operations may include receiving second input data from an accuracy indicator user input element associated with the second data entry field; determining an updated confidence value based at least in part on the second input data; updating the confidence value stored in the data structure with the updated confidence value; and causing an updated confidence indicator representing the updated confidence value to be rendered proximate to the second data entry field on the user device via the user interface. The operations can also, or instead, include generating configuration data comprising the subset of the legible data, a label associated with the data field, and an indication of an association between the subset of the legible data and the data field; and configuring the data extraction function using the configuration data. The operations may further include receiving second input data from an accuracy indicator user input element associated with the data entry field; and based at least in part on the input data, determining a confidence value representing a confidence of the association between the subset of the legible data and the data field, wherein the configuration data further comprises the confidence value.

The methods described herein may include a method for populating data structure fields with data extracted from images that includes rendering, by a computer processor, a display element comprising an image on a user device via a user interface; rendering, by the computer processor, a data entry field on the user device via the user interface, the data entry field comprising an indicator of a data field of a data structure associated with the image; rendering, by the computer processor, a text marker user input element associated with the data entry field and proximate to the data entry field on the user device via the user interface; receiving, by the computer processor, input data from the text marker user input element, the input data indicating a portion of the image and the indicator of a data field; determining, by the computer processor, a subset of data extracted from the image based at least in part on the portion of the image; storing, in a memory by the computer processor, the subset of the data in the data field; and rendering, by the computer processor, the subset of the data in the data entry field on the user device via the user interface.

In examples, storing the subset of the data in the data field includes rendering a second display element comprising the indicator of a data field on a second user interface on the user device; rendering a third display element comprising the subset of the data on the second user interface on the user device; receiving second input data from a second user input element confirming an association of the subset of the data and the data field; and storing the subset of the data in the data field based at least in part on the second input data. The method can further include, based at least in part on the second input data determining a confidence value for the association of the subset of the data and the data field; storing the confidence value in the data structure; and associating the confidence value with the data field in the data structure. In examples, determining the subset of the data extracted from the image includes executing a machine learning data extraction model using the image as input to generate the data as output. The method may also, or instead, include generating training data comprising the subset of the data, a label associated with the data field, and an indication of an association of the subset of the data and the data field; updating a training dataset with the training data; and training the machine learning data extraction model to extract data from images using the training dataset. The training data may include a confidence value determined based at least in part on user input data. In examples, the subset of the data is a first subset of the data, and rendering the data entry field comprises rendering a second subset of the data in the data entry field on the user device via the user interface, wherein the second subset of the data is stored in the data field; storing the first subset of the data in the data field comprises replacing the second subset of the data stored in the data field with the first subset of the data; and rendering the first subset of the data in the data entry field comprises replacing the second subset of the data rendered in the data field with the first subset of the data on the user device via the user interface.

The techniques described herein may also relate to a non-transitory computer-readable medium storing instructions that, when executed by one or more processors, cause the one or more processors to perform operations for populating data structure fields with data extracted from data files, where the operations include rendering a display element comprising an data file on a user device via a user interface; rendering a data entry field on the user device via the user interface, the data entry field comprising an indicator of a data field of a data structure associated with the data file; rendering a user input element associated with the data entry field proximate to the data entry field on the user device via the user interface; receiving input data from the user input element, the input data indicating a portion of the data file and the indicator of a data field; determining a subset of data extracted from the data file based at least in part on the portion of the data file; storing the subset of the data in the data field; and rendering the subset of the data in the data entry field on the user device via the user interface.

In examples, the input data may include one or more of coordinates associated with the portion of the data file, a range of coordinates associated with the portion of the data file, or dimensions of the portion of the data file. In further examples, the data extracted from the data file may be text data, and determining the subset of the data extracted from the data file comprises executing a data extraction function using the data file as input to generate text data as output. The data file may include one or more of an image file, a video file, or an audio file. The operations may include generating data extraction function configuration data comprising the subset of the data, a label associated with the data field, and an indication of an association of the subset of the data and the data field; updating a data extraction function configuration dataset with the data extraction function configuration data; and configuring a data extraction function to extract data from data filed using the data extraction function configuration dataset. The data extraction function configuration data further comprises a confidence value determined based at least in part on the input data.

### BRIEF DESCRIPTION OF THE DRAWINGS

The detailed description is set forth below with reference to the accompanying figures. In the figures, the left-most digit(s) of a reference number identifies the figure in which the reference number first appears. The use of the same reference numbers in different figures indicates similar or identical items. The systems depicted in the accompanying figures are not to scale and components within the figures may be depicted not to scale with each other.

FIG. 1 illustrates an example environment for enhanced data extraction, according to aspects of the present disclosure.

FIGS. 2A-F illustrate example user interfaces that may be generated and manipulated in enhanced data extraction systems and methods, according to aspects of the present disclosure.

FIG. 3 is a flow diagram illustrating an example process for determining extracted data and generating user interfaces for the presentation of such data that may be performed using enhanced data extraction systems and methods according to aspects of the present disclosure.

FIG. 4 is a flow diagram illustrating an example process for generating a visual overlay in a user interface to emphasize extracted data within an image of a document that may be performed using enhanced data extraction systems and methods according to aspects of the present disclosure.

FIG. 5 is a flow diagram illustrating an example process for determining extracted data and a data association of such data with a particular field of a data structure, and for generating training data based on the data association, that may be performed using enhanced data extraction systems and methods according to aspects of the present disclosure.

FIG. 6 is a flow diagram illustrating an example process for determining a confidence of a data association between extracted data and a particular field of a data structure, and for generating training data based on the confidence, that may be performed using enhanced data extraction systems and methods according to aspects of the present disclosure.

FIG. 7 is a flow diagram illustrating an example process for training a data extraction model, and for retraining the data extraction model using training data supplemented by data extraction operation output, that may be performed using enhanced data extraction systems and methods according to aspects of the present disclosure.

### DETAILED DESCRIPTION

Systems and methods are provided for enhanced data extraction. Specifically, the present disclosure relates to data extraction system and method enhancements that facilitate the improved determination of data for data structure population using data sources such as images of scanned documents and other computer-readable data files. These enhancements may provide users with faster and more efficient means of populating data structures while automatically improving text extraction and classification capabilities of data extraction systems.

In examples, a user interface may be generated that represents data in a data structure of a particular type associated with an image of a document. The user interface may include data entry fields that may be prepopulated with data automatically determined by a data extraction system from the image of a document, as well as data entry fields for which the data extraction system has determined no values. A user may activate a text marker user input element to select a portion of the image to associate with a particular data entry field. The system may then correlate the extracted data associated with the selection portion of the image with the data field in the data structure associated with the data entry field. This extracted data may be stored in the data structure for additional processing. The determination correlation may also be used to supplement training data that may be used to train a machine learning data extraction model and/or a data extraction function and thereby improve its text extraction and classification capabilities.

These enhancements may provide users with more efficient means of populating data structures, reducing the requirement for manual data entry. For example, rather than manually accessing a data field of a data structure (e.g., via a user interface) and typing text into the field, a user may select a portion of an image associated with the data structure using a text marker user input element associated with the data field to automatically correlate the extracted data associated with that portion of the image with the data field. This provides a simple and rapid means of populating unpopulated data fields in a data structure. This may also reduce errors entered in data fields by manual entry of data (e.g., typographical errors). By providing this functionality, users may more quickly review and populate individual data structures, allowing for the processing of a greater number of data structures for a given time period.

These enhancements may also reduce the errors in data structure population operations. For example, the disclosed user interfaces may display data populated in data fields of a data structure using data extracted from an image of a document. The user may quickly review such data and indicate to the system whether the data is accurate and/or update the data. In examples, the user may activate a user input element to indicate that the data represented in a data field is accurate (or vice versa). Alternatively or additionally, the user may select a portion of the image using a text marker user input element associated with the data field to automatically correlate the extracted data associated with that portion of the image with the data field, replacing the prepopulated data in the data field. These enhancements provide a simple and rapid means of identifying and correcting errors in data fields of data structures.

In addition to the above, the data extraction enhancements may improve the overall performance of a data extraction system and, in particular, text recognition and classification operations executed by such a system. In examples, one or more machine learning data extraction models and/or data extraction functions may be used to recognize text in an image of a document and classify that text as being associated with particular data fields of a data structure. Even though such a model may be initially trained and/or such a function may be initially configured, there will likely be, at least on occasion, data fields left unpopulated by the model/function and/or text recognized in an image of a document that the model/function fails to classify. The disclosed data extraction enhancements may improve the ability of such models and functions to classify text extracted from an image of a document by generating training data for further training of a model and/or configuration data for supplemental configuration of a function based on real-world data generated in real time.

For example, when a user affirmatively indicates (e.g., selects using a text marker user input element and/or any other type of data selection input element) that particular data extracted from an image of a document is associated with a particular data field of a data structure, an enhanced data extraction system may store the correlation of the extracted data and the classification of the data field as training data. This training data may then be included in a training dataset that may be used to train or retrain a machine learning data extraction model. Similarly, when a user indicates a confidence of an association of particular extracted data and a particular data field of a data structure, an enhanced data extraction system may store the correlated extracted data and classification of the data field along with the user-indicated confidence as training data. This training data may also then be included in a training dataset that may be used to train or retrain a machine learning data extraction model. In a similar manner, data representing this correlation between the extracted data and the classification of the data field may be supplemented to configuration data to generate supplemental configuration data that may be used to configure a data extraction function.

A machine learning data extraction model that may be configured in an enhanced data extraction system may be trained and/or retrained using this updated training dataset. For example, the model may be retrained based on the detection of one or more conditions. In examples, a threshold number of updates to the training dataset (e.g., based on user input element manipulations) may be detected to automatically trigger a retraining of the model. In other examples, the model may be retrained after any update to the training dataset and/or periodically. This updating of training data based on real-time user feedback may improve the performance of the model and thereby increase the overall efficiency of data extraction systems and methods while reducing errors. For instance, over time, the model becomes more proficient at text classification based on regular, updated training. This, in turn, will decrease the number of erroneously populated and unpopulated data fields.

A data extraction function that may be configured in an enhanced data extraction system may be configured and/or reconfigured using the supplemental configuration data. In examples, the function may be reconfigured based on the detection of one or more conditions. In examples, a threshold number of updates to the configuration data (e.g., based on user input element manipulations) may be detected to automatically trigger a reconfiguration of the data extraction function. In other examples, the data extraction function may be reconfigured after any update to the data extraction function configuration data and/or periodically. This updating of configuration data based on real-time user feedback may improve the performance of the data extraction function and thereby increase the overall efficiency of data extraction systems and methods while reducing errors. For instance, over time, the data extraction function may become more proficient at text classification based on regular, updated reconfiguration based on real-time user feedback. This may decrease the number of erroneously populated and unpopulated data fields.

The improvements in data extraction and classification facilitated by the disclosed systems and methods can reduce the overall usage of various resources as well. For example, as the system becomes better at classifying extracted data and populating data fields of data structures based on such classification (e.g., based on updating training data retraining as described herein), fewer user interactions will be required to generate accurately populated data structures. Fewer user interactions will result in fewer resources dedicated to generating user interfaces and processing and exchanging user data. This approach can significantly reduce memory usage and processing requirements, particularly for data structures that may include hundreds or thousands of data fields for which data entry fields may need to be generated, presented, and potentially manipulated. As a result, relatively limited computational resources may be able to handle the presentation and user interaction aspects of even complex data structures as the processing (e.g., populating) of such complex data structures may be largely automated and performed on back-end systems and devices executing the disclosed enhanced data extraction systems and methods. This offloading of the resource-intensive aspects of data extraction and data structure population may result in reduced lag and improved responsiveness at user devices. This benefit may increase over time as the data extraction and data structure population operations become increasingly more efficient through training data updating and model retraining, as described above.

To achieve the above technical benefits (among others), the system may render user interface elements corresponding to data entry fields on a user device and may detect a user activation of a data entry field. When this occurs, the system may render a visual overlay over a portion of an image of a document that is associated with the data entry field (e.g., associated with the data stored in the data field of the data structure represented by the data entry field). The system may further render user input elements, in some cases associated with data entry fields, on the user device and may detect a user activation of a user input element. When this occurs, the system may responsively render corresponding user input elements and other visual interface elements, such as a text marker user input element indicating a selection of a portion of an image of a document, a confidence indicator, etc.

The present disclosure provides an overall understanding of the principles of the structure, function, manufacture, and use of the systems and methods disclosed herein. One or more examples of the present disclosure are illustrated in the accompanying drawings. Those of ordinary skill in the art will understand that the systems and methods specifically described herein and illustrated in the accompanying drawings are non-limiting embodiments. The features illustrated or described in connection with one embodiment may be combined with the features of other embodiments. Such modifications and variations are intended to be included within the scope of the appended claims. Additional details are described below with reference to several example embodiments.

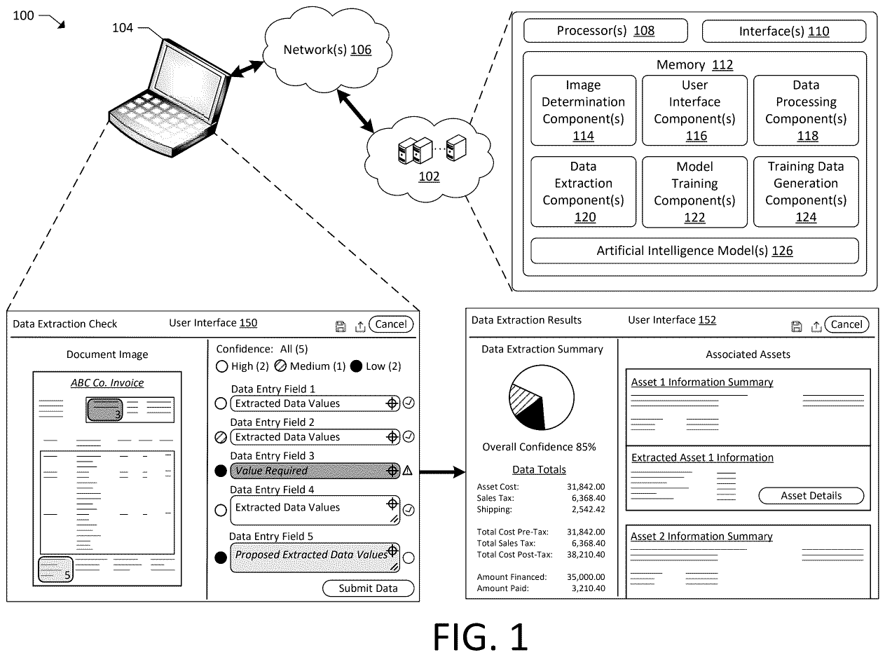

FIG. 1 illustrates a system environment 100 for implementing enhanced data extraction systems and methods. The system environment 100 may include a remote system 102, a client device 104, and a communication network 106. In examples, the remote system 102 may comprise one or more processors and non-transitory computer-readable media storing instructions. The instructions, when executed by the one or more processors, may cause the remote system 102 to perform various operations related to enhanced data extraction, as described in detail below.

The client device 104 may be configured to display user interface elements corresponding to data entry fields. In examples, the remote system 102 may cause the user interface elements to be rendered on the client device 104 via a user interface (such as user interface 150 and/or user interface 152). The user interface elements may represent various types of data entry fields, such as text input boxes, dropdown menus, buttons, and/or checkboxes. The user interface elements may further represent display elements configured to display data provided by the remote system 102 to the client device 104 for storage in a memory of the client device 104 and use in rendering such data in a user interface. The user interface elements may further represent user input elements configured to detect user activation of such elements and responsively generate data that may be stored in a memory of the client device 104, rendered in a user interface, and/or transmitted to the remote system 102.

The communication network 106 may facilitate data exchange between the remote system 102 and the client device 104. In examples, the communication network 106 may include wired or wireless connections, or a combination of both. The communication network 106 may enable the transmission of instructions (otherwise described herein as commands) from the remote system 102 to the client device 104 for rendering the user interface elements, as well as the transmission of user input data from the client device 104 back to the remote system 102.

The system environment 100 may be configured to implement the processes for enhanced data extraction as described herein. By utilizing the components of the system environment 100, the disclosed data extraction enhancements may be applied to improve the extraction of data for data structure population processes. The remote system 102 may include several components that work together to implement these data extraction enhancements. In examples, the remote system 102 may include one or more processors 108, an interface component 110, and memory 112. The processors 108 may be configured to execute instructions stored in the memory 112 to perform various operations related to enhanced data extraction. In examples, the processors 108 may process user input data received from the client device 104 and generate appropriate responses or actions (e.g., instructions) based on the input. The interface component 110 may facilitate communication between the remote system 102 and other components of the system environment 100, such as the client device 104. In examples, the interface component 110 may manage the transmission of data and instructions over the communication network 106.

The memory 112 may store various software components and data structures used in implementing data extraction enhancements. In examples, the memory 112 may include one or more image determination components 114, one or more user interface components 116, one or more data processing components 118, one or more data extraction components 120, one or more model training components 122, one or more training data generation components 124, and/or one or more artificial intelligence models 126.

The image determination component(s) 114 may be configured to determine images that may be processed for data extraction as described herein. For example, the image determination component(s) 114 may be configured to retrieve or access one or more images stored on a remote or local data storage (e.g., memory, disk, database, etc.). The image determination component(s) 114 may also, or instead, be configured to communicate with an image source device, such as a scanner, camera, mobile device, etc., to receive images. Although images may be referred to herein in the description of various examples, any other form of “raw” data may be similarly processed as described herein. For example, video files may be collected and processed as described herein to extract data (e.g., including, in examples, using video transcription processes, systems, and/or models). Likewise, audio files may be collected and processed as described herein to extract data (e.g., including, in examples, using audio transcription processes, systems, and/or models). Any other form of raw data may be collected, accessed, received, or otherwise determined by the image determination component(s) 114 for further processing according to the disclosed enhanced data extraction systems and methods.

The user interface component(s) 116 may determine the configuration of a user interface, including the relative locations and implementations of various user interface elements. Based on this configuration, the user interface component(s) 116 may be configured to generate instructions for transmission (e.g., via the interface component 110) to the client device 104 to cause the client device 104 to render a user interface, such as those described below, on a display. The user interface component(s) 116 may handle the rendering and management of individual user interface elements, such as data entry fields, user input elements, and display elements.

The data processing component(s) 118 may be configured to perform the various data processing of determined extracted data as described herein. For example, the data processing component(s) 118 may be configured to populate fields of a data structure using extracted data indicated via a user interface, by a machine learning data extraction model, and/or by a data extraction function as described herein. The data processing component(s) 118 may further be configured to generate or initialize data structures; retrieve, access, or otherwise determine data structures stored on a remote or local data storage (e.g., memory, disk, database, etc.); update data structures; delete data structures; and otherwise perform any data structure manipulation that may be implemented by an enhanced data extraction system.

The data extraction component(s) 120 may be configured to perform data extraction operations as described herein. For example, the data extraction component(s) 120 may be configured to perform optical character recognition (OCR) operations on images of documents to determine text data represented by such documents. Alternatively or additionally, the data extraction component(s) 120 may be configured to perform transcription operations on audio and/or video data to determine text data that may represented in such data. The data extraction component(s) 120 may be configured to perform any other operations that may extract text data and/or other types of data from a raw data file for further processing, as described herein. Note that the data extraction component(s) 120 may interoperate and/or be integrated with (e.g., as a component of) one or more machine learning data extraction models, such as the artificial intelligence model(s) 126, and/or one or more data extraction functions.

The model training component(s) 122 may be configured to perform the machine learning model training operations as described herein. The model training component(s) 122 may include one or more training datasets used to train one or more machine learning data extraction models. These training datasets may be generated and/or updated by the training data generation component(s) 124 and provided to the model training component(s) 122. In examples, the model training component(s) 122 may train a machine learning data extraction model to classify data (e.g., text data) extracted from an image (or other raw data) into classifications that may be associated with various fields of a type of data structure. This classified data may then be provided to the data processing component(s) 118 for populating fields of a particular data structure of that type. The model training component(s) 122 may also, or instead, be configured to configure and/or reconfigure data extraction functions using data extraction function configuration data as described herein.

The model training component(s) 122 may also, or instead, be configured to determine when and whether to train or retrain a model. For example, the model training component(s) 122 may be configured to receive an indication of an updated training dataset from the training data generation component(s) 124 and determine, in response, whether to retrain an active machine learning data extraction model and/or reconfigure an active data extraction function. In examples, the model training component(s) 122 may be configured to retrain a model in response to determining that a threshold quantity of training dataset updates have been performed and/or in response to determining that a threshold quantity of training dataset data has been updated (e.g., added to the dataset). In examples, the model training component(s) 122 may be configured to retrain a model in response to an indication (e.g., any indication) of a training dataset update. The model training component(s) 122 may also, or instead, be configured to retrain a model using a training dataset on a periodic or scheduled basis and/or in response to a detection of a particular condition or combination of conditions. By retraining a model as the training dataset is updated, the disclosed systems and methods facilitate constant improvement of such a model, thereby increasing the overall performance and efficiency of a data processing system.

The training data generation component(s) 124 may be configured to generate and/or update training data that may be used by the model training component(s) 122 to train one or more machine learning models as described herein. For example, the training data generation component(s) 124 may generate an initial training dataset using historical data structure population data that may then be used to train a machine learning data extraction model to perform data extraction operations. The training data generation component(s) 124 may also, or instead, be configured to receive user-indicated text data and associated classifications and/or confidences that may then be used to update a training dataset. This updated training dataset may be used to retrain an operational machine learning model and/or train a new machine learning model to perform data extraction operations as described herein. Similarly, the training data generation component(s) 124 may generate an initial data extraction function configuration dataset using historical data structure population data that may then be used to configure a data extraction function to perform data extraction operations. The training data generation component(s) 124 may also, or instead, be configured to receive user-indicated text data and associated classifications and/or confidences that may then be used to update a data extraction function configuration dataset. This updated configuration dataset may be used to reconfigure an operational data extraction function and/or configure a new data extraction function to perform data extraction operations as described herein.

The artificial intelligence model(s) 126 may be trained to determine classifications for data (e.g., text data) extracted from an image (and/or other raw data). These classifications may be associated with various fields of a type of data structure. For example, the artificial intelligence model(s) 126 may include a machine learning data extraction model and/or a data extraction function that may determine a particular classification for a subset of text data extracted from an image of a document as described herein. In examples, the machine learning data extraction model and/or a data extraction function may use text data proximate to the subset of text data and/or otherwise represented in the image to determine a classification for the subset of text data. The model and/or function may also, or instead, use other characteristics of the extracted text data, such as the font, location within the document, format, orientation, illustrations, and/or any other content that may be included in the image and represented as extracted data to determine a classification for a particular subset of extracted text data.

In examples, a machine learning data extraction model and/or a data extraction function of the artificial intelligence model(s) 126 may process the extracted data from an image of a document to determine classifications for various subsets of the extracted data that may then be provided to the data processing component(s) 118 for use in populating the fields of a data structure. These populated fields, along with indicators of unpopulated fields of the data structure, may be used by the user interface component(s) 116 to generate instructions that may be transmitted to the client device 104 to cause that device to render a user interface. The classifications determined by the model and/or function may be accompanied by confidence values that may also be used by the user interface component(s) 116 in generating user interface instructions. User input data received via such a user interface may be used by the data processing component(s) 118 to further populate and/or update the fields of the data structure. Such user input data may also, or instead, be used by the training data generation component(s) 124 to update a training dataset and/or configuration dataset that may be used by the model training component(s) 122 to further train and/or configure the machine learning data extraction model and/or any other model or function of the artificial intelligence model(s) 126.

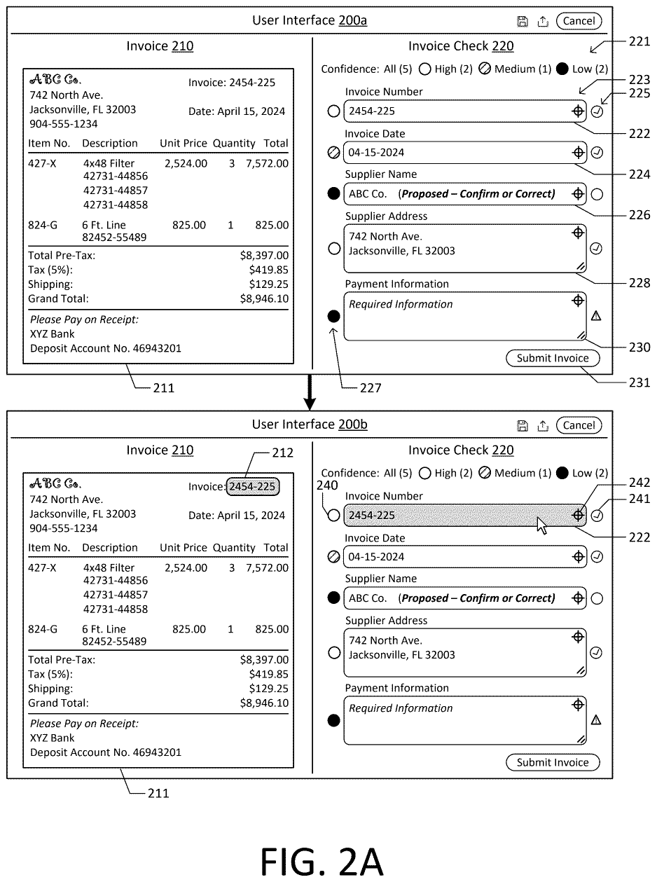

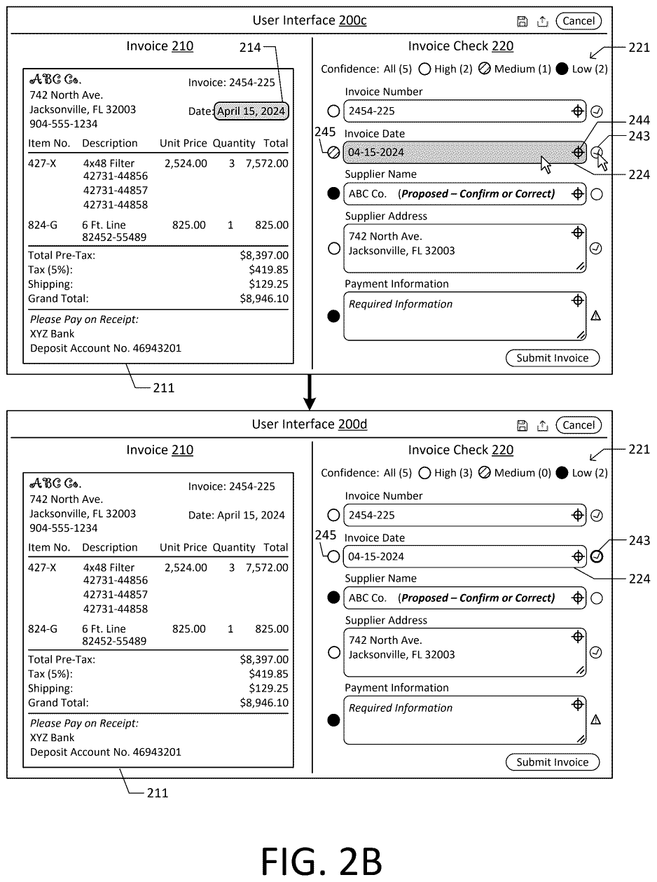

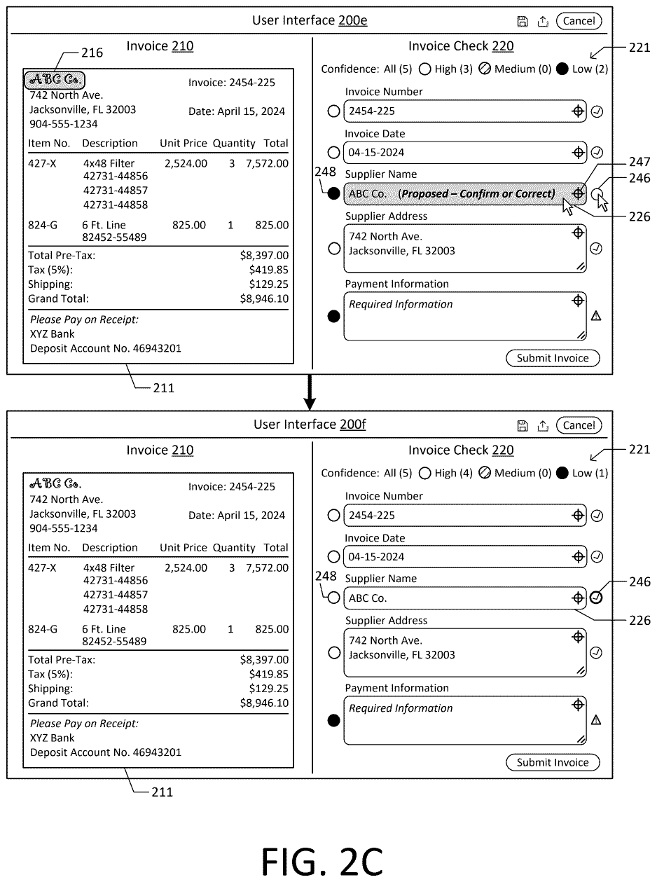

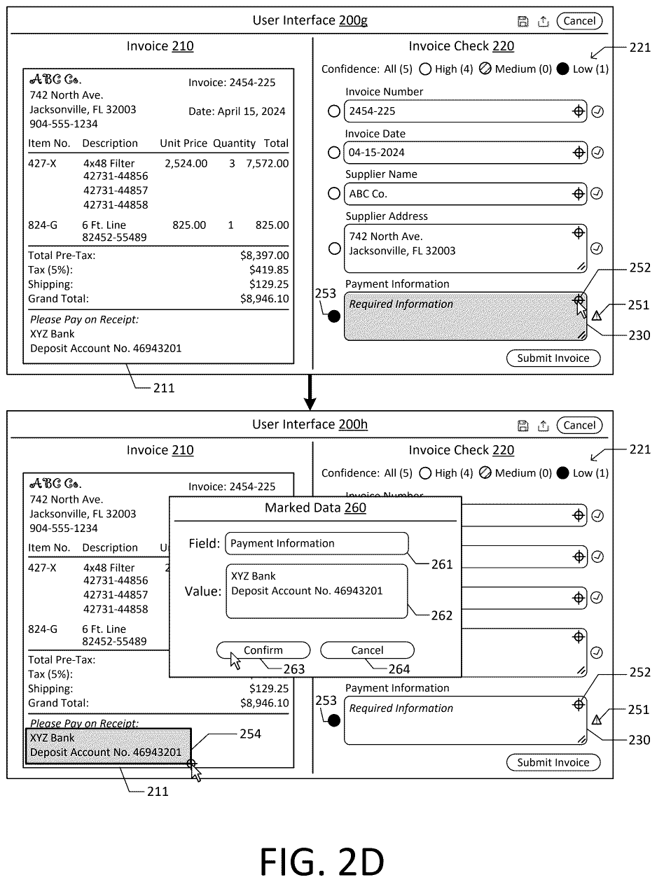

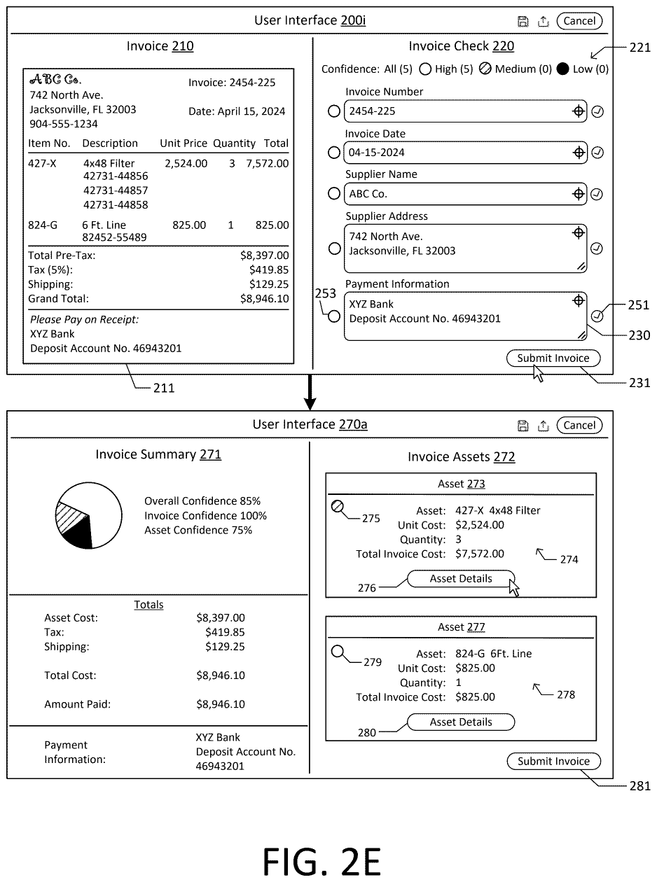

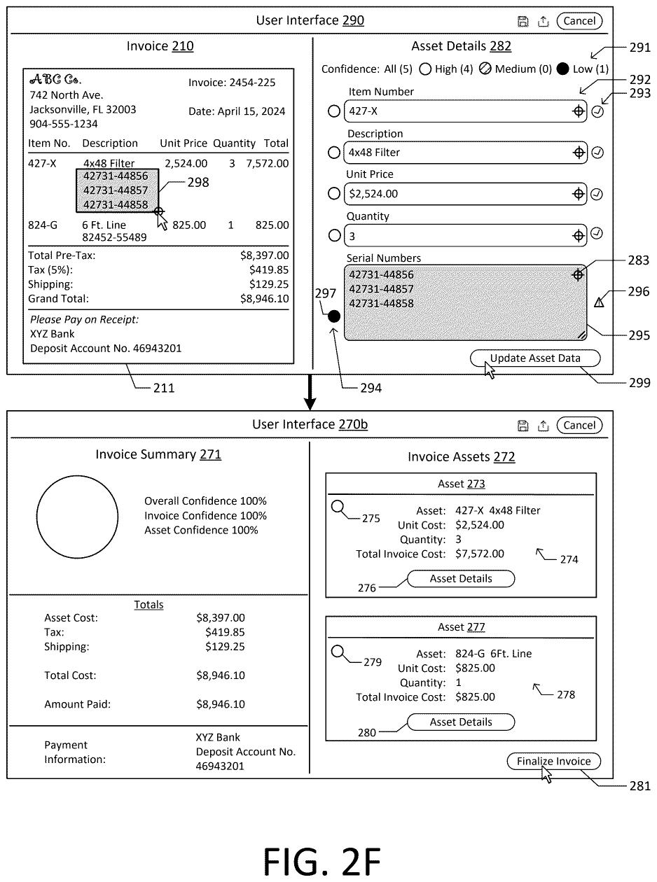

To illustrate the above, and utilizing FIG. 1 as an example, the user interface 150 may serve as an interface for user interaction with the client device 104, presenting a set of data entry fields and other user interface elements. This user interface 150 may be dynamically rendered based on instructions received from the remote system 102, utilizing various components such as the user interface component(s) 116. The user interface 150 may include a variety of user input elements and input methods, such as text fields, buttons, and/or checkboxes, allowing users to enter data efficiently. The user interface 150 may feature a text marker user input element (described in detail in FIGS. 2A-F) that enables users to select a portion of an image displayed on the user interface 150 associated with a subset of data extracted from the image. This subset of data may then be used to populate and/or update data entry fields of the user interface 150, potentially improving data structure population completion. The user interface 150 may also incorporate other user input elements, enabling users to indicate confidence in an association between particular extracted data and a field of a data structure represented by a data entry field of the user interface 150. The user-indicated subsets of data, associations with fields of a data structure, and/or confidence may further be used, for example, by the training data generation component(s) 124, to generate and/or update training data for model training.

Initially, the user interface component(s) 116 may receive a transmission of data from the client device 104 indicating a detection of user input associated with a particular document (or other raw data, such as an audio or video file). In response to this data, the user interface component(s) 116 generate instructions to render the user interface 150. These instructions may be based on a data structure determined by the data processing component(s) 118 that may be associated with the particular document associated with the user input detected at the client device 104 (as indicated by the data received from that device). These instructions may include instructions to render data entry fields (e.g., data entry fields 1, 2, 3, etc., illustrated in the user interface 150) associated with particular fields of the determined data structure. The instructions may include instructions to label such data entry fields based on the field type, label, and/or classification indicated in the data structure. The instructions may also include instructions to populate such data entry fields using values stored in the associated fields in the data structure if such fields are populated (e.g., data entry fields 1, 2, 4, and 5). Data entry fields associated with unpopulated fields may be left blank or may include an indicator of needed data (e.g., data entry field 3).

The instructions may also include instructions to render various user input elements and display elements. For instance, the user interface 150 may include a display element rendering the document associated with the user input detected at the client device 104 (e.g., “ABC Co. Invoice”). The user interface 150 may also, or instead, include one or more display elements indicating a status of a data entry field. The user interface 150 may also, or instead, include one or more display elements indicating a confidence of an association of the values presented in a data entry field with a field of a data structure represented by that data entry field. The user interface 150 may also, or instead, include one or more display elements representing a legend of confidence indicators and/or total numbers of data entry fields associated with particular confidence indicators.

In examples, an individual data entry field may represent a particular field in a data structure. The data structure may be associated with a particular document and populated with data extracted from that document (e.g., using output from a machine learning data extraction model). The data structure may further include data indicating a confidence that the extracted data included in a field is associated with that field. In some cases, one or more fields of the data structure may be unpopulated. Where the field is unpopulated and/or the associated confidence is relatively low, the disclosed enhanced data extraction systems and methods provide a means of updating and/or confirming the data stored in that field.

For example, data entry fields 1 and 4 of the user interface 150 may be rendered with extracted data values included in the fields of the data structure with which these data entry fields are associated. This data structure may be associated with the “ABC Co. Invoice” document rendered in the document image display element of the user interface 150, and the extracted data used in the data entry fields of the user interface 150 may be data extracted from this document. The user interface 150 may be further rendered with “high” confidence indicators proximate to the data entry fields 1 and 4, indicating that a machine learning data extraction model determined with relatively high confidence that the extracted data values are associated with the fields of the data structure with which these data entry fields are associated. In a similar manner, the data entry field 2 of the user interface 150 may be rendered with extracted data values included in the field of the data structure with which this data entry field is associated. The user interface 150 may be further rendered with a “medium” confidence indicator proximate to the data entry field 2, indicating that the machine learning data extraction model determined with relatively medium confidence that the extracted data values are associated with the field of the data structure with which this data entry field is associated.

As noted, some fields of a data structure may be unpopulated. For example, the field of the data structure associated with the “ABC Co. Invoice” document that is associated with the data entry field 3 of the user interface 150 may be unpopulated. This may be due to the machine learning data extraction model being unable to determine an association between data extracted from the document and that particular field. In such examples, a user may activate a text marker user input element rendered proximate to an unpopulated data entry field to select a portion of the rendered document. The extracted data associated with this selected portion may then be used to populate that data entry field and the associated field of the data structure, as described in more detail herein. For instance, a user may manipulate the text marker user input element proximate to the data entry field 3 to select portion 3 of the “ABC Co. Invoice” document and associate the extracted text associated with that portion with the data entry field 3 and the field in the data structure associated with that data entry field. The client device 104 may detect this selection of portion 3 of the document and transmit the selection (e.g., coordinates and/or other parameters of the selection, for instance, relative to the image of the document) to the user interface component(s) 116, which may interoperate with other components of the remote system 102 to determine the extracted data associated with that portion. Along with this transmission, the client device 104 may transmit a data structure identifier, an image identifier, a data entry field identifier, and/or a data structure field identifier determined based on the particular text marker user input element used. The remote system 102 may use this identifier to determine a field of a data structure to populate with the determined extracted data.

A user may wish to update values of data entry fields that are populated. For example, the field of the data structure associated with the “ABC Co. Invoice” document that is associated with the data entry field 5 of the user interface 150 may be populated with a “low” confidence extracted data value, indicating that the machine learning data extraction model was able to determine an association between data extracted from the document and that particular field, but has relatively low confidence in the association. In such examples, a user may activate a text marker user input element rendered proximate to a populated data entry field to select a portion of the rendered document. The extracted data associated with this selected portion may then be used to replace or update that data entry field and the associated field of the data structure, as described in more detail herein. For instance, a user may manipulate the text marker user input element proximate to the data entry field 5 to select portion 5 of the “ABC Co. Invoice” document and associate the extracted text associated with that portion with the data entry field 5 and the field in the data structure associated with that data entry field. The client device 104 may detect this selection of portion 5 of the document and transmit the selection (e.g., coordinates and/or other parameters of the selection, for instance, relative to the image of the document) to the user interface component(s) 116, which may interoperate with other components of the remote system 102 to determine the extracted data associated with that portion. Along with this transmission, the client device 104 may transmit a data structure identifier, an image identifier, a data entry field identifier, and/or a data structure field identifier determined based on the particular text marker user input element used. The remote system 102 may use this identifier to determine a field of a data structure to replace to update with the determined extracted data.

A user may further provide input indicating a confidence with an associated of extracted data and a field (as represented by a data entry field). For instance, confidence indicator user input elements may be rendered in user interface 150 proximate to data entry fields based on commands received from the user interface component(s) 116. These confidence indicators may indicate a confidence determined by a machine learning data extraction model for a determined association between extracted data and a field as represented by the associated data entry field. These confidence indicators may also be configured for user activation that may generate input data adjusting the associated confidence values, as described in more detail herein. For instance, a user may activate the confidence indicator user input element proximate to the data entry field 5 (e.g., empty circle) of the user interface 150. In response to detecting this activation, the client device 104 may transmit an indication of the activation (e.g., along with coordinates and/or other parameters of the confidence indicator user input element) to the user interface component(s) 116. Along with this transmission, the client device 104 may transmit a data structure identifier, an image identifier, a data entry field identifier, and/or a data structure field identifier determined based on the particular confidence indicator user input element activated. The remote system 102 may use this identifier and the confidence indicator user input element data to determine a field of a data structure and an appropriate confidence value update. The user interface component(s) 116 may send a command to the client device 104 to render the confidence indicator user input element in a manner reflecting the updated confidence.

As described in more detail herein, these updated data structure field values and/or confidence values may be used by the remote system 102 (e.g., by the training data generation component(s) 124) to generate one or more updated training datasets that may then be used to train or retrain (e.g., by the model training component(s) 122) one or more machine learning data extraction models of the artificial intelligence model(s) 126.

In examples, the user interface 150 may be rendered, based on instruction generated and transmitted to the client device 104 by the user interface component(s) 116, with user input elements allowing the user to indicate that modifications to the data entry fields and associated data (e.g., confidence values) are complete. In the user interface 150, such an element may be represented by the “submit data” control. In response to detecting this activation, the client device 104 may transmit an indication of the activation to the user interface component(s) 116 along with, in examples, a data structure identifier, an image identifier. The user interface component(s) 116 may use this identifier to generate instructions to render another user interface that may summarize the data extracted from the document and represented in the associated data structure. The user interface component(s) 116 may interoperate with other components of the remote system 102 as described herein to determine these instructions. The user interface component(s) 116 may then transmit the instructions to the client device 104 to render the user interface.

For example, the user interface component(s) 116 may transmit instructions to the client device 104 to render the user interface 152 that may include various display elements and user input elements. Among these display elements may be an overall confidence indicator, various summarizations of data extracted from the associated document (e.g., “ABC Co. Invoice”) and represented in the data structure associated with the document, and further data associated with items that may have been detected in the extracted data. Among these user input elements may be controls allowing the user to access additional data and/or user interfaces. Additional details of such interfaces and the instructions and data associated with their rendering are provided herein.

In examples, the exchange of data and/or information as described herein may be performed only in situations where a user has provided consent for the exchange of such information. For example, a user may be provided with the opportunity to opt in and/or opt out of data exchanges between devices and/or with the systems and/or for performance of the functionalities described herein. Additionally, when one of the devices is associated with a first user account and another of the devices is associated with a second user account, user consent may be obtained before performing some, any, or all of the operations and/or processes described herein.

As used herein, a processor, such as processor(s) 108, may include multiple processors and/or a processor having multiple cores. Further, the processors may comprise one or more cores of different types. For example, the processors may include application processor units, graphic processing units (GPUs), and so forth. In one implementation, the processor may comprise a microcontroller and/or a microprocessor. The processor(s) 108 may include a GPU, a microprocessor, a digital signal processor and/or other processing units or components known in the art. Alternatively, or in addition, the functionally described herein can be performed, at least in part, by one or more hardware logic components. For example, and without limitation, illustrative types of hardware logic components that can be used include field-programmable gate arrays (FPGAs), application-specific integrated circuits (ASICs), application-specific standard products (ASSPs), system-on-a-chip systems (SOCs), complex programmable logic devices (CPLDs), etc. Additionally, each of the processor(s) 108 may possess its own local memory, which also may store program components, program data, and/or one or more operating systems.

The memory 112 may include volatile and nonvolatile memory, removable and non-removable media implemented in any method or technology for storage of information, such as computer-readable instructions, data structures, program component, or other data. Such memory 112 includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, RAID storage systems, or any other medium which can be used to store the desired information and which can be accessed by a computing device. The memory 112 may be implemented as computer-readable storage media (“CRSM”), which may be any available physical media accessible by the processor(s) 108 to execute instructions stored on the memory 112. In one basic implementation, CRSM may include random access memory (“RAM”) and Flash memory. In other implementations, CRSM may include, but is not limited to, read-only memory (“ROM”), electrically erasable programmable read-only memory (“EEPROM”), or any other tangible medium which can be used to store the desired information and which can be accessed by the processor(s).

Further, functional components may be stored in the respective memories, or the same functionality may alternatively be implemented in hardware, firmware, application specific integrated circuits, field programmable gate arrays, or as a system on a chip (SoC). In addition, while not illustrated, each respective memory, such as memory 112 discussed herein may include at least one operating system (OS) component that is configured to manage hardware resource devices such as the network interface(s), the I/O devices of the respective apparatuses, and so forth, and provide various services to applications or components executing on the processors. Such an OS component may implement a variant of the FreeBSD operating system as promulgated by the FreeBSD Project; other UNIX or UNIX-like variants; a variation of the Linux operating system as promulgated by Linus Torvalds; the FireOS operating system from Amazon.com Inc. of Seattle, Washington, USA; the Windows operating system from Microsoft Corporation of Redmond, Washington, USA; LynxOS as promulgated by Lynx Software Technologies, Inc. of San Jose, California; Operating System Embedded (Enea OSE) as promulgated by ENEA AB of Sweden; and so forth.

The network interface(s) 110 may enable messages between the components and/or devices shown in environment 100 and/or with one or more other remote systems, as well as other networked devices. Such network interface(s) 110 may include one or more network interface controllers (NICs) or other types of transceiver devices to send and receive messages over the network.

For example, each of the network interface(s) 110 may include a personal area network (PAN) component to enable messages over one or more short-range wireless message channels. For instance, the PAN component may enable messages compliant with at least one of the following standards IEEE 802.15.4 (ZigBee), IEEE 802.15.1 (Bluetooth), IEEE 802.11 (WiFi), or any other PAN message protocol. Furthermore, each of the network interface(s) 110 may include a wide area network (WAN) component to enable message over a wide area network.

In some instances, the remote system 102 or portions thereof may be local to an environment associated the client device 104. In some instances, some or all of the functionality of the remote system 102 may be performed by the client device 104. Also, while various components of the remote system 102 have been labeled and named in this disclosure and each component has been described as being configured to cause the processor(s) to perform certain operations, the described operations may be performed by some or all of the components and/or other components not specifically illustrated.

In light of the above, the enhanced data extraction systems and methods as described herein improve data structure population operations, reduce computational load on user devices by decreasing manual population of data entry fields, and contribute to reduced error rates in data entry and processing by utilizing the image determination component(s) 114, the user interface component(s) 116, the data processing component(s) 118, the data extraction component(s) 120, the model training component(s) 122, the training data generation component(s) 124, and the artificial intelligence model(s) 126, as described more fully herein.

FIGS. 2A-F illustrate user interfaces that may be rendered on a client device, such as the client device 104 of FIG. 1, in response to instructions generated and transmitted by a remote system, such as the remote system 102 of FIG. 1. In the examples described in regard to these figures, an invoice document, an invoice data structure, and an image of the invoice document will be used to illustrate the various operations that may be performed by enhanced data extraction systems and methods. However, these examples are provided for illustrative purposes and do not limit the scope of the disclosed subject matter. Any other type of document, raw data, data structure, and data representation (e.g., video, audio, image, etc.) may be used with any operation described herein, and all such examples are within the scope of the instant disclosure.

The process illustrated by the user interfaces described in regard to FIGS. 2A-F may include a process to ensure the accuracy of an invoice. The steps performed by an enhanced data extraction system in this example are described from initially determining an invoice for review to determining an accurate invoice (e.g., 100% confidence of data accuracy) to provide a thorough description of the various aspects of the disclosed subject matter. However, any individual operation described in this example may be performed in isolation and/or in combination with one or more other operations of any type.

FIG. 2A illustrates a user interface 200a that may be displayed on a client device, such as the client device 104 from FIG. 1. The user interface 200a may include various user interface elements for data entry, manipulation, and display. The user interface 200a may be generated at the client device in response to instructions received from an enhanced data extraction system, such as the remote system 102 of FIG. 1. In examples, the enhanced data extraction system may determine an image of a document, such as image 211 of an invoice. This image determination may be based on data received from the client device indicating the detection of user input indicating such an image or any other data associated with such an image. The system may generate instructions to render the image 211 of the invoice in an invoice display element 210 of the user interface 200a.

The system may, upon receipt of data identifying the image 211, extract data from the image 211 and populate a data structure with various subsets of the extracted data. For example, the system may execute a machine learning invoice data extraction model trained to generate extracted invoice data for fields of an invoice data structure. The system may use the image 211 as input to this model (and/or extracted data based thereon, for instance, generated by a text recognition process) to generate individual units of extracted data and associated classifications as output. The model may further generate a confidence value representing a confidence of the individual associations of units of extracted data and classifications. Alternatively, the data structure associated with the image 211 may have been previously generated. In such examples, the system may retrieve or otherwise access this data structure, for example, from an invoice database, local or remote invoice data store, etc. As noted, the data extraction process may not result in values for every field of a data structure. Therefore, the determined invoice data structure of this example may have both populated and unpopulated fields.

Using the invoice data structure associated with the image 211, the system may generate instructions to render various elements of the invoice check display element 220. The display element 220 may include data entry fields 223 that may be prepopulated with data from associated fields of the invoice data structure. For example, an invoice number data entry field 222 may be populated with an invoice number value stored in an invoice number field of the invoice data structure associated with the image 211. An invoice date data entry field 224 may be populated with an invoice date value stored in an invoice date field of the invoice data structure associated with the image 211. A supplier name data entry field 226 may be populated with a supplier name value stored in a supplier name field of the invoice data structure associated with the image 211. A supplier address data entry field 228 may be populated with a supplier address value stored in a supplier address field of the invoice data structure associated with the image 211. A payment information data entry field 230 may be populated with a payment information value stored in a payment information field of the invoice data structure associated with the image 211. However, in this example, the payment information field of the invoice data structure may be empty or null, and therefore, the payment information data entry field 230 may be empty or, as in this example, populated with default text indicating that a value is needed for this field.

The display element 220 may also, or instead, include display elements representing other data associated with the invoice data structure associated with the image 211. In examples, the display element 220 may be rendered with confidence indicator display elements 227. Individual confidence indicator display elements may indicate a confidence, as determined by machine learning invoice data extraction model and/or based on user input, of an association between a field in the invoice data structure and the value of that field. The individual confidence indicator display elements may be configured to be rendered proximate to the data entry field associated with the field in the invoice data structure and the value of that field. The various possible values of the confidence indicator display elements 227 may be defined in the legend display element 221, which may also indicate a numerical total number of data entry fields associated with each confidence indicator display element.

In examples, the display element 220 may also, or instead, be rendered with accuracy indicator display elements 225. Individual accuracy indicator display elements may indicate whether the data determined for a data entry field has been confirmed to be accurate, for example, based on user input and/or a threshold level of confidence associated with the data entry field. For example, a populated data entry field associated with a “medium” or “high” confidence value (e.g., data entry fields 222, 224, and 228) may have a positive accuracy indicator display element rendered proximate to it. A populated data entry field associated with a “low” confidence value (e.g., data entry field 226) may have a neutral accuracy indicator display element rendered proximate to it, indicating that a user has not confirmed that this relatively low confidence value for the associated field is accurate. An unpopulated data entry field (e.g., data entry field 230) associated may have a negative accuracy indicator display element rendered proximate to it. The individual accuracy indicator display element may also be an accuracy indicator user input element, allowing a user to activate the element to indicate the accuracy of the data represented in the associated data entry field, as described in more detail below.

The interface 200 may include various other interface elements, such as user input element 231 that may, upon detection of activation by the client device, trigger the transmission of data to the enhanced data extraction system that may cause the system to generate additional user interface rendering instructions. These instructions, when received at the client device, stored in memory, and executed by a processor of the client device, may cause the client device to render another user interface, as described in more detail herein.

The data entry fields described herein may function as user input elements. In examples, the activation of a data entry field in the user interface 200 may, upon detection by the client device, trigger the transmission of data to the enhanced data extraction system that may cause the system to determine and responsively transmit to the client device data indicating a portion of the image 211 that is associated with the extracted data presented in the data entry field. As shown in the user interface 200b, the data entry field 222 may be activated by a user. This may cause the system to shade or otherwise highlight the data entry field 222 as shown here. The system may further render a visual overlay shading or otherwise highlighting the portion 212 of the image 211 corresponding to the extracted data used to determine the value of the field of the invoice data structure represented in the data entry field 222.

As shown here, the data entry field 222 has an associated high confidence indicator display element 240 and a positive accuracy indicator display element 241. However, if desired, a user may manipulate these or other user input elements to adjust the data associated with the data entry field 222. For example, the user may activate the accuracy indicator display element 241 to change it from positive to neutral or negative. This may in turn cause the system to update the confidence associated with the data entry field 222 and adjust the rendering of the confidence indicator display element 240. In another example, the user may manipulate the text marker user input element 242 to select a different portion of the image 211. In response to this selection, the system may determine the extracted data associated with the selected portion and associate that data with the data entry field 222 and/or the field in the invoice data structure associated with the data entry field 222. These and other manipulations are described in more detail herein.

Referring now to FIG. 2B, in user interface 200c, a user may have selected the data entry field 224. The data entry field 224 may have an associated medium confidence indicator display element 245 and a positive accuracy indicator display element 243. Upon activation of the data entry field 224, the system may render a visual overlay shading or otherwise highlighting the portion 214 of the image 211.

A user may review the user interface 200c to determine if adjustments are to be made, particularly related to the data entry field 224. Based on this review, the user may manipulate user input elements to adjust the data associated with the data entry field 224. For example, the user may manipulate the text marker user input element 244 to select a different portion of the image 211. In response to this selection, the system may determine the extracted data associated with the selected portion and associate that data with the data entry field 224 and/or the field in the invoice data structure associated with the data entry field 224.

In another example, the user may activate the accuracy indicator display element 243 to confirm that it should be positive based on a visual comparison of the value indicated in the data entry field 224 and the content of the portion 214 (e.g., determining that the value and the content match). The activation of the accuracy indicator display element 243 may generate data that the client device responsively transmits to the enhanced data extraction system. This data may include information associated with the data entry field 224 as well as data indicating a confirmation of an accuracy indicator. Based on this data, the system may increase the confidence value associated with the field in the invoice data structure associated with the data entry field 224.

Further based on this data, the system may generate instructions to adjust the rendering of the user interface 200 to reflect the adjusted confidence value, which the system may then transmit to the client device. In response to receiving such instructions, the client device may render an adjusted user interface, such as a user interface 200d. As shown here, the confidence indicator display element 245 may be rendered as a high confidence indicator based on the adjusted confidence triggered by data generated by the accuracy indicator display element 243. The rendering of the accuracy indicator display element 243 may also be adjusted to emphasize that a user has confirmed the accuracy on the user interface 200d. As can be seen here, the legend display element 221 may also be updated to show an additional high confidence data entry field and one fewer medium confidence data entry fields.

Referring now to FIG. 2C, in user interface 200e, the user may have next selected the data entry field 226. The data entry field 226 may have an associated low confidence indicator display element 248 and a neutral accuracy indicator display element 246. Upon activation of the data entry field 226, the system may render a visual overlay shading or otherwise highlighting the portion 216 of the image 211. The data entry field 226 may be associated with low confidence due to the machine learning invoice data extraction model determining a low confidence of the association between the field in the invoice data structure represented by the data entry field 226 and the extracted data used to populate that field. This may be the result of various conditions. In this example, as shown here, the font and design of the portion of the image 211 may be unusual or otherwise difficult to recognize as text.

The user may review the user interface 200e to determine if adjustments are to be made, particularly related to the data entry field 226. Based on this review, the user may manipulate user input elements to adjust the data associated with the data entry field 226. For example, the user may determine that the current value of the data entry field 226 is not correct and may manipulate the text marker user input element 247 to select a different portion of the image 211 for the field. In response to this selection, the system may determine the extracted data associated with the selected portion and associate that data with the data entry field 226 and/or the field in the invoice data structure associated with the data entry field 226.

In another example, the user may activate the accuracy indicator display element 246 to change it from neutral to positive based on a visual comparison of the value indicated in the data entry field 224 and the content of the portion 214 (e.g., determining that the value and the content match). The activation of the accuracy indicator display element 246 may generate data that the client device responsively transmits to the enhanced data extraction system. This data may include information associated with the data entry field 226 as well as data indicating the change in an accuracy indicator. Based on this data, the system may increase the confidence value associated with the field in the invoice data structure associated with the data entry field 226.

Further based on this data, the system may generate instructions to adjust the rendering of the user interface 200 to reflect the adjusted confidence value, which the system may then transmit to the client device. In response to receiving such instructions, the client device may render an adjusted user interface, such as a user interface 200f. As shown here, the confidence indicator display element 248 may be rendered as a high confidence indicator based on the adjusted confidence triggered by data generated by the accuracy indicator display element 246. The rendering of the accuracy indicator display element 246 may also be adjusted to emphasize that a user has confirmed the accuracy on the user interface 200f. As can be seen here, the legend display element 221 may also be updated to show an additional high confidence data entry field and one fewer low confidence data entry fields.

Referring now to FIG. 2D, in user interface 200g, the user may have next selected the data entry field 230. The data entry field 230 may have an associated low confidence indicator display element 253 and a negative accuracy indicator display element 251. Because there is no data represented in the data entry field 230 (in this example, just a message indicating that data is required), there is no corresponding portion of the image 211 to highlight. The data entry field 230 may be unpopulated due to the machine learning invoice data extraction model failing to determine an association between the field in the invoice data structure represented by the data entry field 230 and any extracted data from the image 211. This may be the result of various conditions.

The user may review the user interface 200g to determine if adjustments are to be made, particularly related to the data entry field 230. Based on this review, the user may manipulate user input elements to adjust the data associated with the data entry field 230. For example, the user may manipulate the text marker user input element 252 to select a portion of the image 211 for the field.

As shown in user interface 200h, the user may have selected portion 254 of the image 211 using the text marker user input element 252. Based on this selection, the client device may generate a communication containing the coordinates of the selected portion 254 and transmit this communication, along with data identifying the data entry field 230 and/or related data, to the enhanced data extraction system. In response to this communication, the system may determine the extracted data associated with the selected portion 254. The system may transmit this extracted data back to the client device with instructions to render a pop-up window, overlay window, or other means of confirming the association that may be generated between the extracted data and the field associated with the text marker user input element 252.

For example, as shown in FIG. 2D, the system may transmit instructions that cause the client device to render marked data interface 260. The marked data interface 260 may include a display element 261 that identifies the data entry field 230 and/or the invoice data structure field associated with the text marker user input element 252 and/or the data entry field 230. The marked data interface 260 may further include a display element 262 that presents the extracted data associated with the selected portion 254 of the image 211. The marked data interface 260 may further include a user input element 263 that allows the user to confirm that this proposed association is valid, triggering creation of an association between the extracted data and the field. The marked data interface 260 may further include a user input element 264 that allows a user to cancel the creation of this association.

In response to activation of the user input element 263, the client device may transmit data indicating a confirmation of the accuracy of the association between the extracted data represented in the display element 262 and the field represented in the display element 261. Based on this data, the system may store the extracted data in the field associated with the data entry field 230 and generate instructions to adjust the rendering of the user interface 200 to reflect the selected value of the data entry field 230. The system may transmit these instructions to the client device, which may render an adjusted user interface, such as a user interface 200i of FIG. 2E. The system may further update or generate confidence data for the association between the extracted data represented in the display element 262 and the field represented in the display element 261 upon activation of the user input element 263. This confidence data may be stored at the data structure and associated with the field associated with the data entry field 230. This confidence data may also, or instead, be stored with training data that may be generated based on the association between the extracted data represented in the display element 262 and the field represented in the display element 261.

As shown in the interface 200i, the confidence indicator display element 253 for the data entry field 230 may now be rendered as a high confidence indicator based on the adjusted confidence triggered by the text marker user input element selecting data for the data entry field 230. The rendering of the accuracy indicator display element 251 may also be adjusted to emphasize that a user has confirmed the accuracy of the association between the associated field and the data displayed in the data entry field 230 on the user interface 200i. As can be seen here, the legend display element 221 may also be updated to show an additional high confidence data entry field and one fewer low confidence data entry fields. In this example, all of the data entry fields of the invoice check display element 220 are of high confidence and accurate. Accordingly, the user may determine that the review of the invoice image 211 and associated extracted data is complete. The user may activate the user input element 231 to submit the invoice or otherwise indicate that review of this image is complete.

The activation of the user input element 231 may cause the client device to transmit data indicating that the user has accepted or is otherwise finished reviewing the image 211. In response to this data, the enhanced data extraction system may generate and transmit instructions that cause the client device to render a user interface 270a as shown in FIG. 2E. The user interface 270a may present data and elements related to the invoice associated with the image 211. The user interface 270a may include an invoice summary display element 271 present summary data associated with the invoice, such as totals, overall confidence values, and other details.

In examples, an invoice or other documents may be associated with other objects or entities about which information may be generated, processed, and/or stored. In this example, the invoice represented by the image 211 may include descriptions of various assets (e.g., purchased assets as indicated in the invoice). In this example, the user interface 270a may include an invoice assets display element 272 that may include asset display element 273 and asset display element 277, each presenting data associated with an individual asset type. For instance, the asset display element 273 may present asset data 274 and an asset confidence indicator display element 275 that may indicate a relative completeness and/or confidence in the accuracy of the asset data currently available. The asset display element 273 may also include a user input element 276 that may generate another interface presenting further asset details. Similarly, the asset display element 277 may present asset data 278 and an asset confidence indicator display element 279, along with a user input element 280 that may generate another interface presenting further asset details.

As shown here, the asset of the asset display element 273 has a lower (e.g., medium) confidence value indicated by the asset confidence indicator display element 275. This may be contributing to the less than 100% overall confidence of the invoice as indicated in the invoice summary display element 271. Accordingly, the user may activate the user input element 276 to request access to asset details associated with the asset of the asset display element 273.

The activation of the user input element 276 may cause the client device to transmit data indicating that the user has requested additional detail regarding the asset of the asset display element 273. In response to this data, the enhanced data extraction system may generate and transmit instructions that cause the client device to render a user interface 290 as shown in FIG. 2F.

The user interface 290 may include the invoice display element 210 presenting the image 211 of the invoice and the asset details display element 282 with detailed data associated with the asset of the asset display element 273. Among the elements of the asset details display element 273 may be various data entry fields 292, each of which may have an associated accuracy indicator display element 293 and an associated confidence indicator display element 294. The asset details display element 273 may also include a legend display element 291 defining the confidence indicators and indicating a numerical total number of data entry fields associated with each confidence indicator display element.

In this example, the data entry field 295 (“serial numbers”) may have been unpopulated, resulting in an associated low confidence and negative accuracy, as indicated by the respective indicators. In this case, the user may have activated the text marker user input element 283 and used it to select portion 298 of the image 211. Based on this selection, the client device may generate a communication containing the coordinates of the selected portion 298 and transmit this communication, along with data identifying the data entry field 295 and/or related data, to the enhanced data extraction system. In response to this communication, the system may determine the extracted data associated with the selected portion 298. The system may transmit this extracted data back to the client device with instructions to render a pop-up window, overlay window, or other means of confirming the association that may be generated between the extracted data and the field associated with the text marker user input element 283. The may performed in a similar manner as that described above (e.g., in regard to FIG. 2D). Upon user confirmation, the system may store the extracted data in the field associated with the data entry field 295 and generate instructions to adjust the rendering of the user interface 290 to reflect the determined extracted data value of the data entry field 295. The system may transmit these instructions to the client device, which may render an adjusted user interface, or adjust interface elements as shown in user interface 290.

Although not shown here, also as a result of the confirmation of an associated between the extracted data of the portion 298 and the field associated with the data entry field 295, the confidence indicator display element 297 for the data entry field 295 may now be rendered as a high confidence indicator based on the adjusted confidence triggered by the text marker user input element selecting data for the data entry field 295. The rendering of the accuracy indicator display element 296 may also be adjusted to emphasize that a user has confirmed the accuracy of the association between the associated field and the data displayed in the data entry field 295 on the user interface 290. The legend display element 291 may also be updated to show an additional high confidence data entry field and one fewer low confidence data entry fields. The user may activate the user input element 299 to update the asset data or otherwise indicate that review of this asset is complete.

The activation of the user input element 299 may cause the client device to transmit data indicating that the user has accepted or is otherwise finished reviewing the details of the asset of the asset display element 273. In response to this data, the enhanced data extraction system may generate and transmit instructions that cause the client device to render an updated user interface 270b as shown in FIG. 2F. The user interface 270b may present data and elements related to the invoice associated with the image 211 as described in regard to user interface 270a. In this example, the asset display element 273 may be updated based on the updated asset detail acquired via user interface 290, including with an updated asset confidence indicator display element 275 that may indicate a relative high confidence and/or completeness of the asset data currently available. As a result of this update, the overall confidence presented in the invoice summary display element 271 may be increased (e.g., to 100% in this example). The user may activate the user input element 281 to finalize this invoice. The activation of the user input 281 may cause the client device to transmit data indicating that the user has accepted or is otherwise finished reviewing the invoice associated with the image 211.

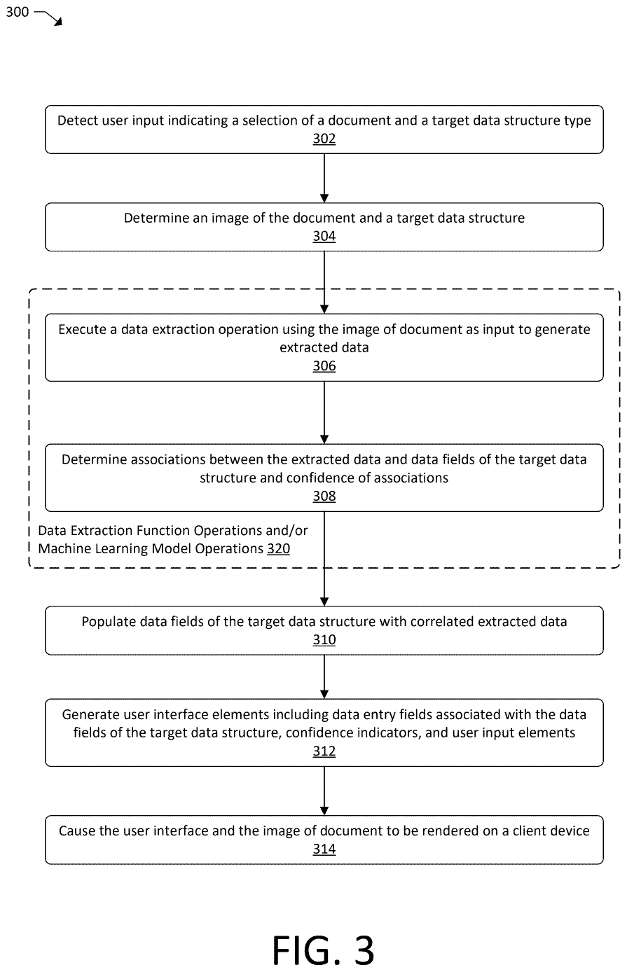

FIGS. 3-7 illustrate processes 300-700 for data extraction enhancements. The processes 600-900 described herein are illustrated as collections of blocks in logical flow diagrams, which represent operations, some or all of which may be implemented in hardware, software or a combination thereof. In the context of software, the blocks may represent computer-executable instructions stored on one or more computer-readable media that, when executed by one or more processors, program the processors to perform the recited operations. Generally, computer-executable instructions include routines, programs, objects, components, data structures and the like that perform particular functions or implement particular data types. The order in which the blocks are described is not a limitation, unless specifically noted. Any number of the described blocks may be combined in any order and/or in parallel to implement the process, or alternative processes, and not all of the blocks need be executed. For discussion purposes, the processes 300-700 are described with reference to the environments, architectures and systems described in the examples herein, such as, for example those described with respect to FIGS. 1 and 2A-F, although the processes 300-700 may be implemented in a wide variety of other environments, architectures and systems.

FIG. 3 illustrates a flowchart of a process 300 for extracting data from a data source and using such data to generate user interface configuration data. The order in which the operations are described is not intended to be construed as a limitation, and any number of the described operations may be combined in any order and/or in parallel to implement process 300.

The process 300 may begin at operation 302 with an enhanced data extraction system (e.g., the remote system 102 and/or any one or more components configured therein) detecting user input associated with a selection of a data source (e.g., a document, an image, a computer-readable data file, etc.) and a target data structure type. For example, the user input may select a document or document data file and an invoice data structure type by selecting a file in a dialog box rendered within an invoice data structure processing application.

At operation 304, the system may determine an image or other representation of the selected data source and the target data structure. For example, the system may retrieve or otherwise access an image of the selected document from remote or local data storage (e.g., memory, disk, database, etc.). The system may further initialize a data structure based on the data structure type indicated at operation 302 and associated the data structure with the document and/or the image of the document. For instance, a document image and an associated data structure may be stored in memory as a single data structure (e.g., the image may be stored in a portion of the data structure). Alternatively, the data structure may be configured with a pointer or other reference data that may be used to obtain or access the image. Alternatively, the system may determine an existing data structure that may be associated with the document and/or the image of the document.

At operation 306, the system may process the image of the document to extract data using a data extraction operation. For example, the system may perform an OCR operation and/or one or more other text recognition operations to determine text data represented by an image of a document. Alternatively or additionally, the system may perform one or more transcription operations to determine text data represented in an audio, video, or other type of data file. In various examples, the system may perform any one or more extraction operations to generate user-readable and/or legible data as output based on processing a computer-readable data file of any type.

At operation 308, the system may determine one or more associations between the extracted data and data fields of the data structure. For example, the system may determine a subset of the extracted data, such as a portions of text data representing one or more words or numbers, that correspond to a field of the data structure. The system may label or classify this subset of the extracted with an indicator that is associated with the corresponding field.

In examples, the operations 306 and 308 may be performed as operations 320 by a data extraction function or a machine learning data extraction model. For example, an image may be provided as input to a data extraction function at operation 306. The data extraction function may perform operations to extract text data from the image and classify one or more portions of the extracted text data with classifications that correspond to fields of a data structure. The data execution function may then generate, as output, identifiers of the portions of text data (e.g., the text data and/or the range of coordinates representing the location of the text data in the image) and the determined classification labels (if applicable), along with a confidence value indicating the confidence of the function that the portions of text data is associated with the determined classification label.

At operation 310, the system may use the field mapping and/or labels determined at the operation 308 to populate one or more data fields of the data structure. For example, the system may identify a data field of the data structure associated with a particular label determined by the system at operation 308. The system may then populate that field with the extracted text data determined to be associated with the particular label at operation 308. The system may further configure the data structure with confidence data determined for the association at operation 308 and/or any other type of data generated at operation 308. As noted, one or more fields of the data structure may remain unpopulated.

At operation 312, the system may generate instructions to render a user interface that presents data stored in the data structure. For example, the system may generate instructions that may cause a client device to render data entry fields representing one or more of the data fields in the data structure (e.g., including labels for such fields). Accompanying such instructions, and any instruction described herein, may be metadata that may be configured at the client device when rendering the instructed user interface(s), but may not be visibly rendered on the user interface. Such metadata may include various indicators and/or identifiers, such as, but not limited to, indicators and/or identifiers for data structures, data fields of data structures, data entry fields, extracted data, images, documents, and so forth. This metadata may be used for performing data extraction operations as described herein without user intervention or knowledge, thus facilitating the efficient and automatic performance of such operations.

The system may further generate instructions that cause the client device to populate such data entry fields with data from the corresponding data structure data fields if such fields are populated. If the corresponding data structure data fields are populated, the system may generate instructions that cause the client device to populate corresponding data entry fields with placeholder information (e.g., “value required,” “no information,” “information required,” etc.). Alternatively, the system may leave such data entry fields unpopulated.

Further at operation 312, the system may generate instructions that may cause a client device to render confidence indicators based on the confidence data associated with the data fields in the data structure corresponding to data entry fields. In examples, the system may determine the particular confidence indicator based on various thresholds. For instance, the system may determine a high confidence indicator based on a confidence value at or above a high confidence threshold (e.g., 90%, 95%, etc.), a medium confidence indicator based on a confidence value below a high confidence threshold but at or above a medium confidence threshold (e.g., 75%, 80%, etc.), and a low confidence indicator based on a confidence value below a medium confidence threshold. Any particular thresholds and/or other criteria may be used to determine a particular confidence indicator for a data entry field.

Further at operation 312, the system may generate instructions that may cause a client device to render accuracy indicators, user input elements, and/or any other user interface elements as described herein. The system may also generate instructions that may cause a client device to render the image of the document in the user interface.

At operation 314, the system may transmit the instructions generated at the operation 312, along with the image of the document and/or a pointer or other reference to the image of the document. These instructions, upon storage in memory at the client device and execution by a processor of the client device, may cause the client device to render the user interface and the elements represented therein, as described in more detail above.

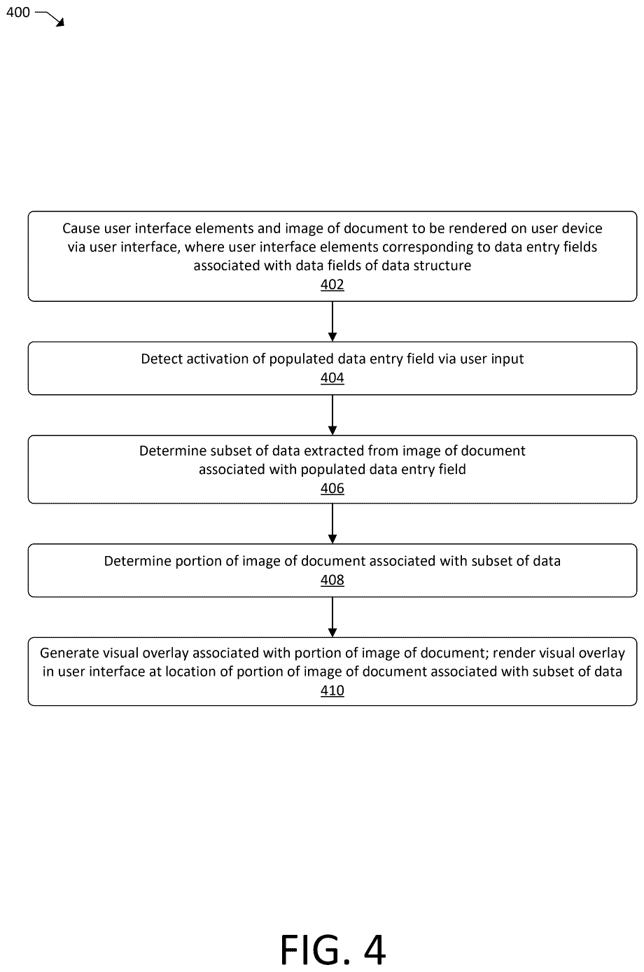

FIG. 4 illustrates a flowchart of a process 400 for rendering a visual overlay over extracted data associated with a data entry field in a user interface. The order in which the operations are described is not intended to be construed as a limitation, and any number of the described operations may be combined in any order and/or in parallel to implement process 400.

The process 400 may begin at operation 402, where an enhanced data extraction system (e.g., the remote system 102 and/or any one or more components configured therein) may transmit instructions to render, on a client device, a user interface that may include various data entry fields corresponding to data fields of a data structure along with the image of a document and/or a pointer or other reference to an image of a document, as described herein. These instructions, upon storage in memory at the client device and execution by a processor of the client device, may cause the client device to render the user interface and the elements represented therein.

At operation 404, the system may detect an activation of a populated data entry field via a user input. For example, a user may activate a data entry field rendered in a user interface on a display of the client device. This activation may cause the client device to generate and transmit data to the system, indicating that a particular data entry field has been activated.

At operation 406, the system may responsively determine the extracted data associated with the activated data entry field. For example, the system may determine a particular field of a data structure associated with the data entry field indicated in the data received from the client device. The system may then obtain, access, or otherwise determine the extracted data populating that field.

At operation 408, the system may determine the portion of the image associated with the data structure that corresponds to the extracted data determined at the operation 406. This may include analyzing the image based on this extracted data to identify the corresponding portion of the image. Alternatively or additionally, the data structure may include such information, and the system may obtain, access, or otherwise determine the portion based on that information. For instance, along with the extracted data, the system may, when performing data extraction and field mapping operations, store data indicating the location in the image of the extracted data when populating a field with the extracted data. This portion location information may be associated with the field in the data structure. The portion location information may take any suitable form, including coordinates associated with the portion, a range of coordinates defining an area of the image from which the extracted data was extracted, dimensions of the portion, etc.

At operation 410, the system may generate instructions to render, on the client device, a visual overlay on the user interface rendered based on the instruction of the operation 402. These instructions may include the location of the portion within the image as well as the dimensions of the portion and/or a range of coordinates defining the portion. The instructions may further include instructions to generate a visual overlay in the area associated with the portion. This overlay may take the form of shading or highlighting the portion. Further at operation 410, the system may transmit these instructions to the client device. These instructions, upon storage in memory at the client device and execution by a processor of the client device, may cause the client device to render the visual overlay in the user interface rendered at the client device.

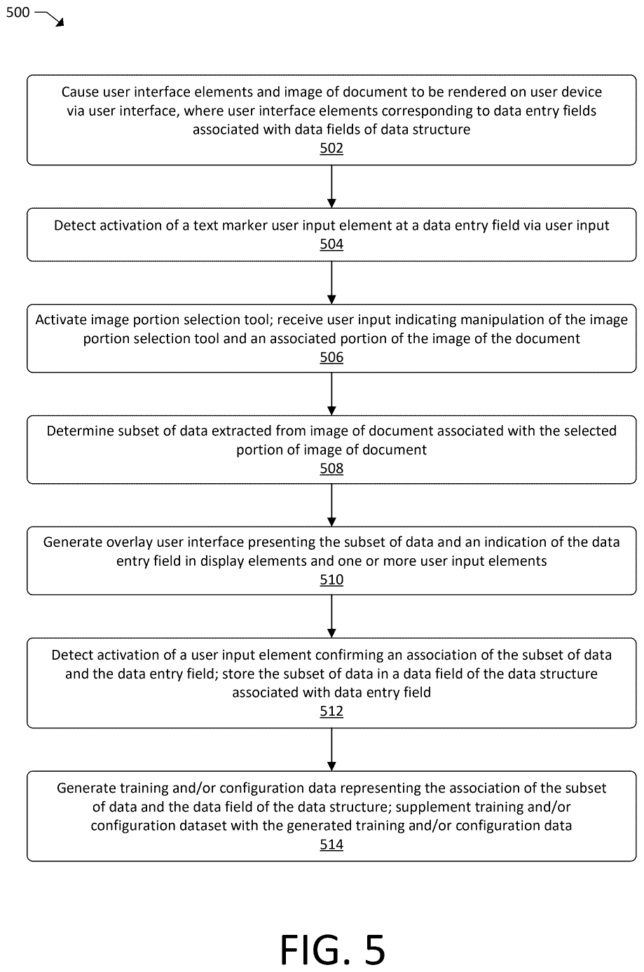

FIG. 5 illustrates a flowchart of a process 500 for populating a data structure with extracted data associated with a data entry field in a user interface based on data generated by a text marker user input element. The order in which the operations are described is not intended to be construed as a limitation, and any number of the described operations may be combined in any order and/or in parallel to implement process 500.

The process 500 may begin at operation 502, where an enhanced data extraction system (e.g., the remote system 102 and/or any one or more components configured therein) may transmit instructions to render, on a client device, a user interface that may include various data entry fields corresponding to data fields of a data structure, various other user interface elements, and the image of a document and/or a pointer or other reference to an image of a document, as described herein. These instructions, upon storage in memory at the client device and execution by a processor of the client device, may cause the client device to render the user interface and the elements represented therein.

At operation 504, the system may detect an activation of a text marker user input element associated with a data entry field via a user input. For example, a user may click on, or initiate a drag of, a text marker user input element rendered in a user interface on a display of the client device (e.g., via a cursor). This activation may cause the client device to generate and transmit data to the system, indicating that a text marker user input element has been activated. Any other data selection input element or other user input element may be used to select one or more portions of a computer-readable data file.

At operation 506, the system may activate an image portion selection tool configured to collect user input indicating a portion of an image. For example, in response to detecting the activation of the text marker at the operation 504, the system may transmit instructions to the client device to place the client device in an image portion selection tool mode where data may be collected that represents and/or is associated with a user-selected portion of an image.

Further at the operation 506, the system may detect a selection of a portion of the image by the text marker user input element. For example, a user may initiate a drag of the text marker user input element rendered in a user interface on a display of the client device while a physical input (e.g., mouse button) is depressed. This selection activity activation, for instance, upon completion (e.g., release of the mouse button), may cause the client device to generate and transmit data to the system indicating that a portion of the image has been selected. In examples, the client device may transmit to the system coordinates, a range of coordinates, and/or dimensions of the selected portion of the image.

At operation 508, the system may determine, from the data extracted from the image, the subset of extracted data associated with the user-selected portion of the image. For instance, the system may determine extracted data associated with the coordinates, range of coordinates, and/or dimensions associated with the portion of the image indicated by the text marker user input element.

At operation 510, the system may generate instructions to render, on the client device, an overlay user interface (e.g., pop-up window, dialog box, etc.) that may be rendered on or over the user interface rendered based on the instruction of the operation 502. The instructions generated at the operation 510 may include instructions to render, in a display element, an identifier of the data entry field associated with the text marker user input element and/or an identifier of a field in the data structure associated with such a data entry field. The instructions generated at the operation 510 may also include instructions to render, in another display element, the extracted data determined to be associated with the selection portion of the image at the operation 508. The generated instructions may also include instructions to render user input elements that allow the user to confirm or cancel the association of the extracted data determined to be associated with the selection portion and the data entry field and/or data structure field (e.g., a “confirm” button and a “cancel” button). Further at operation 510, the system may transmit these instructions to the client device. These instructions, upon storage in memory at the client device and execution by a processor of the client device, may cause the client device to render the overlay user interface in the user interface rendered at the client device.

At operation 512, the system may detect an activation of a user input element rendered on the overlay window (e.g., via a user input), confirming an association of the extracted data determined to be associated with the selection portion and the data entry field and/or data structure field rendered in the overlay window. For example, a user may click on a “confirm” button rendered on the overlay window that may be presented on a display of the client device. This activation may cause the client device to generate and transmit data to the system, indicating that the user has activated the user input element associated with confirming the association.

Further at the operation 512, in response to the data received from the client device, the system may store the extracted data determined to be associated with the selection in the field of the data structure associated with the data entry field associated with the text marker user input element. The system may further generate and transmit instructions to the client device that cause the client device to cease rendering the overlay window. The system may further generate and transmit instructions to the client device that cause the client device to update the rendering of the data entry field associated with the text marker user input element with the extracted data. The system may further generate and transmit instructions to the client device that cause the client device to update the renderings of a confidence indicator and/or an accuracy indicator based on the user confirmation of the association, as described above.

Note that, at operation 512, the system may instead detect activation of a user input element rendered on the overlay window (e.g., via a user input), canceling or otherwise rejecting an association of the extracted data determined to be associated with the selection portion and the data entry field and/or data structure field rendered in the overlay window. For example, a user may click on a “cancel” button rendered on the overlay window that may be presented on a display of the client device. This activation may cause the client device to generate and transmit data to the system indicating that the user has activated the user input element associated with rejecting the association. In response to receiving this data from the client device, the system may generate and transmit instructions to the client device that cause the client device to cease rendering the overlay window without making changes to the data structure.

At operation 514, the system may generate training data and/or configuration data representing the confirmed association of the extracted data determined to be associated with the selection portion and the data structure field. For instance, the system may generate data representing an association of the extracted data and a label or classification associated with the field. The system may further store this data with a training dataset and/or a configuration dataset (e.g., by updating, supplementing, and/or augmenting the respective dataset). The updated training dataset and/or configuration dataset may then be used to train or configure a model or function, respectively, as described herein.

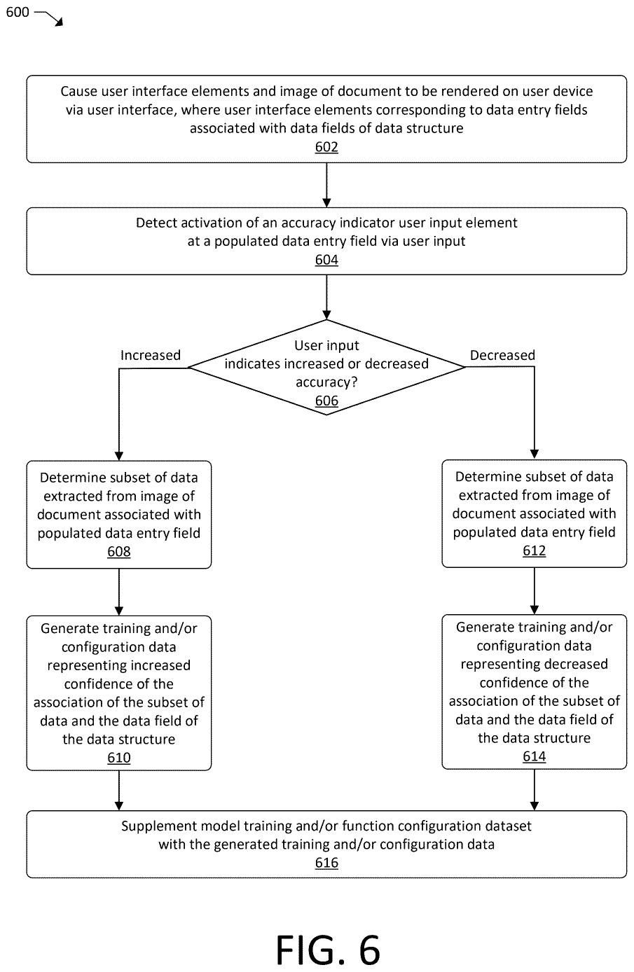

FIG. 6 illustrates a flowchart of a process 600 for updating model training data and/or function configuration data based on accuracy data generated by a user input element. The order in which the operations are described is not intended to be construed as a limitation, and any number of the described operations may be combined in any order and/or in parallel to implement process 600.

The process 600 may begin at operation 602, where an enhanced data extraction system (e.g., the remote system 102 and/or any one or more components configured therein) may transmit instructions to render, on a client device, a user interface that may include various data entry fields corresponding to data fields of a data structure, various other user interface elements, including accuracy indicator user input elements, and the image of a document and/or a pointer or other reference to an image of a document, as described herein. These instructions, upon storage in memory at the client device and execution by a processor of the client device, may cause the client device to render the user interface and the elements represented therein.

At operation 604, the system may detect an activation of an accuracy indicator user input element associated with a data entry field via a user input. An accuracy indicator user input element may indicate, and allow a user to adjust, the accuracy of the data presented in a data entry field (e.g., the extracted data determined to be associated with the associated data structure field). For instance, the accuracy indicator may indicate an accuracy of the association of the data included in a data entry field and the data structure field associated with the data entry field (as described in more detail above).

In examples, a user may click on an accuracy indicator user input element rendered in a user interface on a display of the client device (e.g., by depressing a mouse button). This activation may cause the client device to generate and transmit data to the system indicating that the accuracy indicator user input element has been activated. This data may include information indicating the data entry field associated with the accuracy indicator user input element and/or a current state of the accuracy indicator user input element (e.g., indicating negative, neutral, or positive accuracy).

At operation 606, the system may determine whether the user input data received at the operation 604 indicates that the accuracy of the association between the field and the extracted data associated with the data entry field has increased or decreased. In examples, an activation (e.g., a single activation) of accuracy indicator user input element may advance the state of the accuracy associated with the element in a limited sequence of accuracy levels. For instance, a neutral accuracy indicator that is activated may be advanced to a positive accuracy indicator, a positive accuracy indicator that is activated may be advanced to a negative accuracy indicator, a negative accuracy indicator that is activated may be advanced to a neutral accuracy indicator, and so forth. Other techniques of adjusting an accuracy associated with a data entry field may be additionally or alternatively be used.

If the user input indicates that the accuracy of the association between the field and the extracted data has increased, at operation 608, the system may determine the subset of extracted data associated with the data entry field and/or the data structure field. For instance, the system may determine the data entry field associated with the accuracy indicator user input element and then determine, based on the data entry field, the field of a particular data structure represented by that data entry field. The system may then obtain, access, or otherwise determine the extracted data populating that field. In some examples, the system may further obtain, access, or otherwise determine a confidence value associated with that field.

At operation 610, the system may generate training data and/or configuration data representing the increased accuracy of the association of the extracted data and the data structure field. For instance, the system may generate data representing a relatively high confidence value of the association. Alternatively or additionally, the system may generate data based on a preexisting confidence value for the associated by increasing the preexisting confidence value. This generated training data and/or configuration data may further include the field and/or a label or classification associated with the field as well as the associated extracted data.

At operation 616, the system may store this generated training data and/or configuration data with a training dataset and/or a configuration dataset (e.g., by updating, supplementing, and/or augmenting the respective dataset). The updated training dataset and/or configuration dataset may then be used to train or configure a model or function, respectively, as described herein.

If, at the operation 606, the system determined that the user input indicates that the accuracy of the association between the field and the extracted data has decreased, at operation 612, the system may determine the subset of extracted data associated with the data entry field and/or the data structure field, and, in examples, an associated confidence value, similar to the operation 608.

At operation 614, the system may generate training data and/or configuration data representing the decreased accuracy of the association of the extracted data and the data structure field. For instance, the system may generate data representing a relatively low confidence value of the association. Alternatively or additionally, the system may generate data based on a preexisting confidence value for the associated by decreasing the preexisting confidence value. This generated training data and/or configuration data may further include the field and/or a label or classification associated with the field as well as the associated extracted data.

As noted, at operation 616, the system may store this generated training data and/or configuration data with a training dataset and/or a configuration dataset (e.g., by updating, supplementing, and/or augmenting the respective dataset). The updated training dataset and/or configuration dataset may then be used to train or configure a model or function, respectively, as described herein.

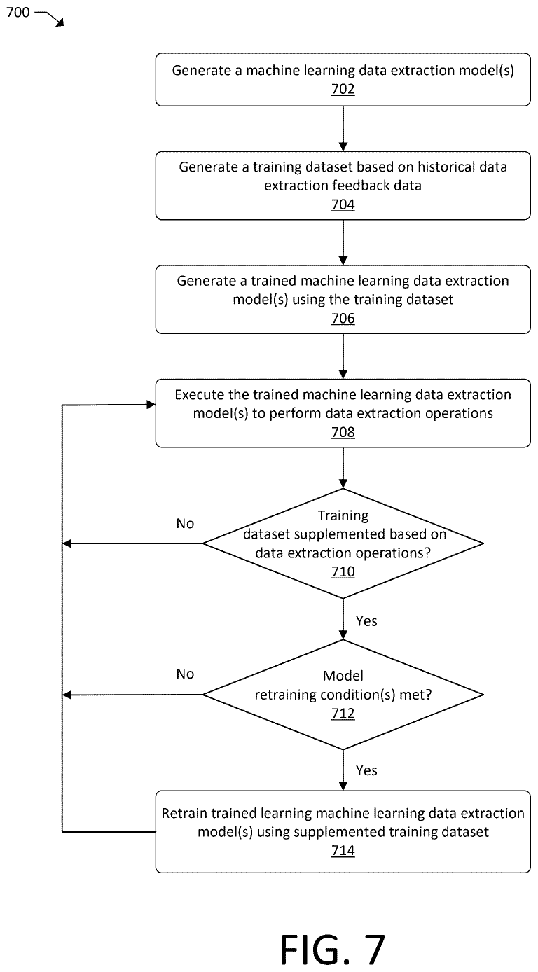

FIG. 7 illustrates a flowchart of a process 700 for retraining a machine learning data extraction model and/or reconfiguring a data extraction function based on various criteria. The order in which the operations are described is not intended to be construed as a limitation, and any number of the described operations may be combined in any order and/or in parallel to implement process 700.

The process 700 may begin at operation 702, where an enhanced data extraction system (e.g., the remote system 102 and/or any one or more components configured therein) may generate a machine learning data extraction model. A number of artificial intelligence techniques may be employed to generate and/or modify models and/or model layers that may be configured to perform the operations described herein. Those techniques may include, for example, decision tree learning, association rule learning, artificial neural networks (including, in examples, deep learning), convolutional neural networks (CNNs) that may include one or more convolution/deconvolution layers, inductive logic programming, support vector machines, clustering, Bayesian networks, reinforcement learning, representation learning, similarity and metric learning, sparse dictionary learning, and/or rules-based artificial intelligence. Alternatively or additionally, at the operation 702, the system may generate a data extraction function that may be capable of being configured to perform the operations described herein.

At operation 704, the system may generate a training dataset based on historical data extraction feedback data. For instance, the system may generate a training dataset that may include training data representing associations between text or other forms of potential extracted data and labels or classifications that may be represented in a data structure. The data representing these associations may further include data indicating a validity, an accuracy, and/or a confidence of the associations. As will be appreciated, training data demonstrating invalid and/or inaccurate associations may be as valuable to training a model as training data demonstrating valid and/or accurate associations. Alternatively or additionally, at the operation 704, the system may generate configuration data for a data extraction function that may be similarly based on historical data extraction feedback data and/or known association data (e.g., valid and/or invalid association data).

At operation 706, the system may generate a trained machine learning data extraction model by training the model generated at the operation 702 using the training dataset generated at the operation 704. This may include updating parameters and/or weightings and/or thresholds utilized by the model to determine associations between text data (or other forms of extracted data) and labels and/or classifications that may be associated with fields in a particular type of data structure. Alternatively or additionally, at the operation 706, the system may configure the data extraction function generated at the operation 702 to generate a configured data extraction function using the configuration data generated at the operation 704. This may also include updating parameters and/or weightings and/or thresholds utilized by the data extraction function to determine associations between text data (or other forms of extracted data) and labels and/or classifications that may be associated with fields in a particular type of data structure.

At operation 708, the system may execute the trained machine learning data extraction model to perform data extraction operations as described herein, including determining extracted data and labeling such data for use in populating fields of a data structure. Alternatively or additionally, at the operation 708, the configured data extraction function may be executed to perform similar operations.

At operation 710, the system may determine whether the training dataset and/or the data extraction function configuration data have been supplemented or otherwise updated as described herein. For instance, when a user input element adjusts the accuracy of an association and/or the confidence of an association, as described above, the training dataset and/or the data extraction function configuration data may be updated with additional and/or modified training data based on this adjustment. In another example, when a text marker user input element selects a portion of an image, resulting in the association of the extracted data with a particular field, label, and/or classification, the training dataset and/or the data extraction function configuration data may be updated with additional and/or modified training data based on this new association.

If there has been no update to the training dataset and/or the data extraction function configuration data, the process 700 may return to the operation 708 to further execute the model and/or function to perform one or more of the disclosed data extraction operations.

If the training dataset and/or the data extraction function configuration data have been updated, the system may determine, at operation 712, whether to retrain the model and/or reconfigure the function based on various conditions. Various conditions may be used to determine whether and when to retrain and/or reconfigure a model and/or function, respectively. As noted above, the system may be configured to retrain or reconfigure after a threshold number of training dataset updates and/or configuration data updates have occurred. In another example, the system may be configured to retrain or reconfigure after a threshold quantity of data has been added to the training dataset and/or the configuration data (e.g., a configured number of bytes of data added). In another example, the system may be configured to retrain or reconfigure after a threshold quantity of data in the training dataset and/or the configuration data has been modified (e.g., a configured number of bytes of data modified). In another example, the system may be configured to retrain or reconfigure periodically or on a configured schedule. In another example, the system may be configured to retrain or reconfigure after any change and/or addition to the training dataset and/or the configuration data. Any other conditions, and any combination of any conditions, may be used to trigger a retraining or reconfiguration.

If model retraining and/or function reconfiguration condition(s) have not been met, the process 700 may return to the operation 708 to further execute the model and/or function to perform one or more of the disclosed data extraction operations.

If model retraining and/or function reconfiguration condition(s) have been met, at operation 714, the system may retrain the trained machine learning data extraction model using the updated training dataset. Alternatively or additionally, at operation 714, the system may reconfigure the data extraction function using the updated extraction function configuration data. Following this retraining and/or reconfiguring, the process 700 may return to the operation 708 to execute the updated model and/or function to perform one or more of the disclosed data extraction operations. In this way, the trained machine learning data extraction model and the data extraction function may be kept up to date and constantly improved, steadily increasing the efficiency and accuracy of the overall data extraction systems and methods.

The present disclosure provides an overall understanding of the principles of the structure, function, manufacture, and use of the systems and methods disclosed herein. One or more examples of the present disclosure are illustrated in the accompanying drawings. Those of ordinary skill in the art will understand that the systems and methods specifically described herein and illustrated in the accompanying drawings are non-limiting embodiments. The features illustrated or described in connection with one embodiment may be combined with the features of other embodiments, including as between systems and methods. Such modifications and variations are intended to be included within the scope of the appended claims.

While the foregoing invention is described with respect to the specific examples, it is to be understood that the scope of the invention is not limited to these specific examples. Since other modifications and changes varied to fit particular operating requirements and environments will be apparent to those skilled in the art, the invention is not considered limited to the example chosen for purposes of disclosure and covers all changes and modifications that do not constitute departures from the true spirit and scope of this invention.

Although this disclosure describes embodiments having specific structural features and/or methodological acts, it is to be understood that the claims are not necessarily limited to the specific features or acts described. Rather, the specific features and acts are merely illustrative embodiments that fall within the scope of the claims.

What is claimed is:

1. A system for populating data structure fields with legible data extracted from computer-readable files, the system comprising:
one or more processors; and
non-transitory computer-readable media storing instructions that, when executed by the one or more processors, cause the system to perform operations comprising:
executing a data extraction function using a computer-readable data file as input to generate legible data as output;
causing a display element comprising the computer-readable data file to be rendered on a user device via a user interface;
causing a data entry field to be rendered on the user device via the user interface, the data entry field comprising metadata indicating a data field of a data structure associated with the computer-readable data file;
causing a data selection input element associated with the data entry field to be rendered proximate to the data entry field on the user device via the user interface;
receiving input data from the data selection input element, the input data indicating a portion of the computer-readable data file and the metadata indicating the data field;
determining a subset of the legible data associated with the portion of the computer-readable data file;
determining the data field based at least in part on the metadata indicating the data field;
based at least in part on determining the data field, storing the subset of the legible data in the data field; and
causing the subset of the legible data to be rendered in the data entry field on the user device via the user interface.

2. The system of claim 1, wherein the operations further comprise:
determining a second subset of the legible data associated with a second data field of the data structure;
causing a second data entry field associated with the second data field to be rendered on the user device via the user interface; and
causing the second subset of the legible data to be rendered in the second data entry field on the user device via the user interface.

3. The system of claim 2, wherein the operations further comprise:
executing the data extraction function using the computer-readable data file as the input to generate second output indicating the second subset of the legible data, a label associated with the second data field, and an association between the second subset of the legible data and the label; and
storing the second subset of the legible data in the second data field based at least in part on the label.

4. The system of claim 3, wherein:
the second output further indicates a confidence value representing a confidence of the association between the second subset of the legible data and the label, and
the operations further comprise:
storing the confidence value in the data structure;
associating the confidence value with the second data field in the data structure; and
causing a confidence indicator representing the confidence value to be rendered proximate to the second data entry field on the user device via the user interface.

5. The system of claim 4, wherein the operations further comprise:
receiving second input data from an accuracy indicator user input element associated with the second data entry field;
determining an updated confidence value based at least in part on the second input data;
updating the confidence value stored in the data structure with the updated confidence value; and
causing an updated confidence indicator representing the updated confidence value to be rendered proximate to the second data entry field on the user device via the user interface.

6. The system of claim 1, wherein the operations further comprise:
generating configuration data comprising the subset of the legible data, a label associated with the data field, and an indication of an association between the subset of the legible data and the data field; and
configuring the data extraction function using the configuration data.

7. The system of claim 6, wherein the operations further comprise:
receiving second input data from an accuracy indicator user input element associated with the data entry field; and
based at least in part on the input data, determining a confidence value representing a confidence of the association between the subset of the legible data and the data field,
wherein the configuration data further comprises the confidence value.

8. A method for populating data structure fields with data extracted from images, the method comprising:
rendering, by a computer processor, a display element comprising an image on a user device via a user interface;
rendering, by the computer processor, a data entry field on the user device via the user interface, the data entry field comprising an indicator of a data field of a data structure associated with the image;
rendering, by the computer processor, a text marker user input element associated with the data entry field and proximate to the data entry field on the user device via the user interface;
receiving, by the computer processor, input data from the text marker user input element, the input data indicating a portion of the image and the indicator of a data field;
determining, by the computer processor, a subset of data extracted from the image based at least in part on the portion of the image;
storing, in a memory by the computer processor, the subset of the data in the data field; and
rendering, by the computer processor, the subset of the data in the data entry field on the user device via the user interface.

9. The method of claim 8, wherein storing the subset of the data in the data field comprises:
rendering a second display element comprising the indicator of a data field on a second user interface on the user device;
rendering a third display element comprising the subset of the data on the second user interface on the user device;
receiving second input data from a second user input element confirming an association of the subset of the data and the data field; and
storing the subset of the data in the data field based at least in part on the second input data.

10. The method of claim 9, further comprising, based at least in part on the second input data:
determining a confidence value for the association of the subset of the data and the data field;
storing the confidence value in the data structure; and
associating the confidence value with the data field in the data structure.

11. The method of claim 8, wherein determining the subset of the data extracted from the image comprises executing a machine learning data extraction model using the image as input to generate the data as output.

12. The method of claim 11, further comprising:
generating training data comprising the subset of the data, a label associated with the data field, and an indication of an association of the subset of the data and the data field;
updating a training dataset with the training data; and
training the machine learning data extraction model to extract data from images using the training dataset.

13. The method of claim 12, wherein the training data further comprises a confidence value determined based at least in part on user input data.

14. The method of claim 8, wherein the subset of the data is a first subset of the data, and wherein:
rendering the data entry field comprises rendering a second subset of the data in the data entry field on the user device via the user interface, wherein the second subset of the data is stored in the data field;
storing the first subset of the data in the data field comprises replacing the second subset of the data stored in the data field with the first subset of the data; and
rendering the first subset of the data in the data entry field comprises replacing the second subset of the data rendered in the data field with the first subset of the data on the user device via the user interface.

15. A non-transitory computer-readable medium storing instructions that, when executed by one or more processors, cause the one or more processors to perform operations for populating data structure fields with data extracted from data files, the operations comprising:
rendering a display element comprising a data file on a user device via a user interface;
rendering a data entry field on the user device via the user interface, the data entry field comprising an indicator of a data field of a data structure associated with the data file;
rendering a user input element associated with the data entry field proximate to the data entry field on the user device via the user interface;
receiving input data from the user input element, the input data indicating a portion of the data file and the indicator of a data field;
determining a subset of data extracted from the data file based at least in part on the portion of the data file;
storing the subset of the data in the data field; and
rendering the subset of the data in the data entry field on the user device via the user interface.

16. The non-transitory computer-readable medium of claim 15, wherein the input data comprises one or more of:
coordinates associated with the portion of the data file,
a range of coordinates associated with the portion of the data file, or
dimensions of the portion of the data file.

17. The non-transitory computer-readable medium of claim 15, wherein:
the data extracted from the data file comprises text data, and
determining the subset of the data extracted from the data file comprises executing a data extraction function using the data file as input to generate text data as output.

18. The non-transitory computer-readable medium of claim 15, wherein the data file comprises one or more of an image file, a video file, or an audio file.

19. The non-transitory computer-readable medium of claim 15, wherein the operations further comprise:
generating data extraction function configuration data comprising the subset of the data, a label associated with the data field, and an indication of an association of the subset of the data and the data field;
updating a data extraction function configuration dataset with the data extraction function configuration data; and
configuring a data extraction function to extract data from data filed using the data extraction function configuration dataset.

20. The non-transitory computer-readable medium of claim 15, wherein the data extraction function configuration data further comprises a confidence value determined based at least in part on the input data.
